(19) United States
(12) Patent Application Publication
(10) Pub. No.: US 2014/0061140 A1
(43) Pub. Date: Mar. 6, 2014

(54) SCREEN ASSEMBLY

(71) Applicant: Marshall Graham Bailey, Dubai (AE)

(72) Inventor: Marshall Graham Bailey, Dubai (AE)

(21) Appl. No.: 14/111,364

(22) PCT Filed: Apr. 13, 2012
(86) PCT No.: PCT/GB2012/000337

§ 371 Date: Nov. 18, 2013

(30) Foreign Application Priority Data
Apr. 13, 2011 (GB) 1106298.1

(51) Int. Cl. B01D 33/03; B07B 1/28

(52) U.S. Cl. CPC B01D 33/0376; B07B 1/28
USPC 210/780; 210/486; 210/418; 210/359; 210/346; 210/335; 210/499

(57) ABSTRACT

A screen assembly (32) for use in a vibratory screening machine (1) includes first and second screen units (34, 36) spaced apart by a support frame (38) interposed between the screen units. The first and second screen units (34, 36) each comprise a screen panel (46, 48) including screening material. The screen panel (46) of the first screen unit (34) is disposed, in use, across a top side of the support frame (38) and the screen panel of the second screen unit (36) is disposed, in use across an underside of the support frame (38). The support frame (38) and second screen unit (36) define at least one channel (50) formed and arranged so that solids collected by the second screen unit may be transported off an end of the screen unit by the vibratory action of a vibratory screening machine. Modular screen assemblies are described. Methods of using the screen assemblies are also described.

### FIELD OF THE INVENTION

The invention relates to replaceable screen panels and screen assemblies and methods for their use. The panels, assemblies and methods are for use with vibrating screening machines such as shale shakers as used for the separation of drilled solids generated during the process of drilling an oil well, from drilling mud. The panels, assemblies and methods are also applicable in vibrating screening machines used in technologies such as mineral processing, dewatering, processing of waste fluid streams, quarrying, pharmaceuticals and food processing.

### BACKGROUND TO THE INVENTION

Screening is used to separate solids according to particle size and/or to separate solids from fluids. The solids to be screened may be dry or wet and may often be screened from a flowable solids and liquids mixture (slurry). Screening processes are used in many industries including: mineral and metallurgical processing, quarrying, pharmaceuticals, food and the drilling of oil, water and gas wells. The design of screening equipment varies widely but will generally be of one of two types, either static or moving.

Static screens generally include coarse screens and sieve bends. These are normally mounted at an angle such that solids on the screen roll over it by gravity and in so doing either pass through the screen or roll off it. Static screens are typically used to screen down to 5 mm. Sieve bends may be used to screen finer sizes.

Moving screens are generally described according to the motion of the screen. Types will typically include: revolving rotary screens, shaking screens, gyratory screens, linear screens and high frequency vibratory screens. Moving screen arrangements normally have two elements, the screen panel and the screening machine.

Screen panels will generally be mounted in the screening machine in such a manner that they may be removed and replaced either when worn or damaged or when a change in separation size is required. Screen panels may be constructed of widely differing materials, including but not limited to, woven wire mesh, wedge wire, moulded plastics, synthetic woven fabrics and drilled plates of either plastic or metal. Screen panels are made with different hole sizes to provide separation at different sizes.

The function of the screen panel is:
To retain solids above screen aperture size on the panel.
To transmit the motion generated within the screening machine to the solids and liquid (if present), such that the fluid and undersized solids pass through the screen and the solids retained on the screen are transported on the screen to a point of discharge from the screen.
To allow fluid and solids under screen aperture size to pass through the screen.
To ideally offer resistance to blinding and plugging of the screen apertures from solids of similar size to the screen aperture size.

The screening machine design will vary widely according to the movement that it is required to impart to the screen panel, the number of screen panels, the method of feeding the panels, the process application, working environment and process capacity required. The screening machine motion will normally be arranged to impart energy to the screen panel such that:
Solids under screen aperture size are moved in such a manner that encourages them to pass through the screen. These solids are termed ‘undersize’
Solids that are larger than the screen aperture and as such cannot pass through the screen are retained by the screen and transported off the screen. These solids are generally termed ‘oversize’. Any fluid discharged from the screen with the oversize solids is generally termed ‘screen overflow’.
Fluids carrying solids are encouraged to pass through the screen. Fluid passing through the screen with the undersize solid (i.e. the filtrate) is generally termed ‘screen underflow’.

Moving screens are used for the screening of either dry or wet solids and or the screening of solids from fluids. Dry screening will typically be used for separation of dry solids down to 1 mm diameter. For sizes lower than 1 mm, wet screening will normally be used. This method eliminates dust. Wet screening will normally be the screening of solids from flowable slurry, being a mixture of solids and a fluid (liquid).

Where a slurry is screened to remove the majority of the fluid from the solids, without any specific need to size the solids, the function of the screen is generally termed ‘dewatering’. This term is applied to the function of the machine and will apply to slurries that are made with water or any other liquid as the fluid. Where slurry is screened to remove solids falling within one or more specific size ranges the function of the screen is termed ‘classification’.

In addition to screening equipment making use of screen panels as described above, other types of solids/liquids separators can be used, for example centrifuges such as decanting centrifuges, to separate a solids/liquids mixture.

Whilst screening machines, especially vibratory screening machines such as the so called ‘shale shakers’ of the oil well drilling industry are used with success in methods of solids/liquids separation, especially classification, there is a need to improve throughput and effectiveness. This is especially the case where available space is severely limited, for example on offshore oil rigs, and the option of increasing equipment size or the numbers of machines employed may not be available.

During the drilling of an oil well, fluid known as mud is circulated, under pressure, inside the drilling assembly to the drill bit. One of the functions of the drilling mud is to carry the rock cuttings generated during the drilling process at the drill bit, out of the borehole.

The constitution of drilling mud varies according to the mud type. Generally the mud will contain a fluid phase and a solids phase. The solids phase may include a weighting agent such as Barite that is added to the fluid to control the density of the mud. Other weighting agents can be employed. Generally weighting agents are made of materials that are of high specific gravity, typically within the range of 3.2 to 4.4 SG. The weighting agent will normally be an inert material that will have minimum impact on the viscosity and fluid properties of the drilling fluid when added in various concentrations. The size of the weighting agent particles will normally be below 74 microns with the majority of the particles being under 40 microns diameter. As the weighting agent is added to the drilling mud to control the density of the drilling mud during use, it is generally desirable that the weighting agent is not removed from the mud system but retained within it. Other desirable solids can be incorporated into the mud system such as ‘Bridging’ and ‘Lost Circulation Material’. These solids will generally be within a desirable size range such that they perform the function for which they are designed.

When the drilling mud arrives at the drilling rig after use in drilling, the solids fraction of the mud will contain desirable solids and drilled solids. The drilled solids are generally undesirable solids comprised predominantly of rock but can contain metal fragments. The drilled solids are undesirable as these are generally rock cuttings that if allowed to accumulate at increased concentrations result in undesirable effects on the fluid properties of the mud. As the concentrations of drilled solids in a mud increases the fluid properties are affected until the mud becomes unusable and requires replacement or the addition of new mud to dilute the concentration of drilled solids such that the desired fluid properties are restored. The removal and control of the concentrations of drilled solids is generally regarded as a most important activity in contributing to the successful, safe and economic drilling of an oil well, within the planned time and cost.

The process of recycling used drilling mud should remove drilled solids (at least above a selected size range) while leaving desirable solids such as weighting material within the fluid. Drilled solids are conventionally removed from the mud using first shale shakers to screen the fluid. Rock cuttings above screen size are removed during screening and the fluid passes into storage tanks for subsequent mechanical and chemical processing, where this is desirable, and ultimate recirculation to the oil well. After screening at the shale shaker, additional solids separation techniques can be applied to remove any drilled solids that have passed through the shale shaker, being smaller than the screen size fitted to the shale shaker.

Shale shakers are conventionally employed in preference to other equipment due to the following characteristics
No feed tank and pump are required to feed pressurised mud to the equipment.
Equipment is simple for the operator to understand and easy to operate and maintain.
Installed space and weight are typically low.
Power consumption is low.
Basis of separation is by size.
Separation efficiency is easily determined being directly relative to the mesh size fitted.
Separation efficiency is not variable with fluid properties provided the fluid passes through the mesh size fitted.

The drilling mud returning to the drilling rig from a well normally contains a low concentration of drilled solids within a large volume of fluid. The drilled solids removal system is thus required to process a large volume of fluid to remove a small volume of drilled solids. Consequently the size of a drilled solids removal system has historically been directly relative to the volume of fluid to be processed and not the volume of solids to be removed.

The oil industry has previously employed hydrocyclone and screen (e.g. in shale shakers) combinations to concentrate the volume of solids into a smaller volume of fluid. One such typical apparatus is called a mud cleaner. Mud cleaners typically employ hydrocyclone assemblies mounted above a shale shaker or shakers. However the operation of the hydrocyclone has been shown to be inefficient for a number of reasons. Historically this analysis led the industry away from hydrocyclone/screen combinations and towards the development of higher capacity shale shakers such as the AX1 Shale Shaker manufactured by Axiom Process Limited. Such shale shakers typically have multiple decks, two or more screen assemblies stacked one above the other in a single basket that is vibrated to give the desired screening action. These multiple decks can be used in parallel or series modes. In series mode screening is carried out sequentially through the screen assemblies, each fitted with a screen mesh or aperture size that is successively finer, allowing smaller and smaller solids particles to be screened from the fluid—this is called Progressive Screening.

One or more shale shakers are used depending upon the volume of fluid being pumped and the separation efficiency required. Generally as finer screens are fitted to the shale shaker the process capacity of the shaker decreases while the efficiency of separation of solids increases. Typically screening will take place using screens, generally made of woven wire mesh, of between 10 and 400 mesh. These screens will contain between 10 and 400 wires per inch respectively and aperture hole size will vary according to the weave pattern and diameter of the wire used in the weave.

To achieve the required process capacity and separation efficiency, a drilling rig shale shaker installation will typically contain between one and eight shale shakers, although some installations can employ more machines. Machines will be employed to work in parallel where the fluid from the oil well is split into multiple streams and processed by an equal number of machines. Installations of shale shakers can thus be appreciable in size.

Alternatively an installation can contain multiple machines working sequentially (in series), each separating at a progressively finer size. Alternatively an installation can contain a combination of machines working in parallel and in series.

The need to design a vibratory screening machine to provide the required fluid throughput while transporting solids to the point of discharge from the screen has resulted in conventional machines being of a larger size or used in greater numbers than is ideal where space and weight are restricted by either physical or economic factors.

Shale Shakers are generally classified by the motion of vibration and number of screen decks, each deck carrying one or more screen assemblies for carrying out a screening step (filtering off solids above a selected size). Examples of motion are typically but not limited to: orbital, elliptical, linear, balanced elliptical, compound or circular.

Screen types generally fall into two groups, those tensioned within the machine and those that are pre-tensioned on a frame such that the screen frame may be clamped or otherwise secured into the vibratory machine without the need to tension the screening material.

Screen panels in screen assemblies will incorporate screening material which will typically be, but is not limited to, woven wire mesh manufactured from stainless steel, bronze, high tensile steel, or other suitable metal or metal alloys, a suitable plastic or combination of plastics and other materials. Alternatively screening material can be, but not limited to, wedge wire, moulded plastic, perforated metal or plastic. The screening material may be arranged in single or multiple layers according to the aperture size, material type and duty required. If multiple layers are used they are normally arranged such that the upper layer, that will be the first to be contacted by the solid and fluid, and is normally the element with the smallest aperture size, is mounted over progressively stronger elements of increasing aperture size. The second and subsequent layers may be selected not only to provide support for upper layers but to interact with the upper layer so as to reduce the tendency of the upper layer of screening material to suffer from plugging, by particles near to the mesh aperture size. The screen panels will be attached to a component by which the screen is mounted and fixed into the shale shaker.

One example of a conventional un-tensioned screen is commonly referred to as a hook strip screen. Single or multiple layers of mesh are clamped together with hooks attached to either side of the screen panel. When fitted to the shale shaker the hooks engage with suitably shaped hooked tensioning rails. The screen panel is positioned over a suitably spaced and shaped screen support framework. The tensioning rails are provided with a means of tensioning the screen panel (mesh layer or layers). Typically this can be but is not limited to bolts and springs. When tensioned the screen is pulled over the support framework to form a supported tensioned screen.

An alternative type of typical conventional screen is a commonly referred to as a pre-tensioned screen. This will typically be comprised of a rigid or semi rigid support means onto which screening material is fixed. Typical examples of support means are, but are not limited to, a metal or plastic framework, either fabricated, moulded, formed or cast, alternatively a perforated sheet of metal or plastic. Screens may be of single or multiple layers and mesh elements may be un-tensioned, tensioned at different tensions or subject to the same tensioning prior to fixing to the support means. Screen elements (meshes) may be flat or corrugated into a sandwich prior to bonding to the support framework. The pre-tensioned screen and its frame once manufactured generally form a single unit. Fixing methods are typically but not limited to bolting, clamping with wedges, hydraulics or pneumatics or other suitable system.

The oil well drilling industry is increasingly recognising that under certain circumstances it is desirable to maintain solids of a specific size range within the drilling fluid. As conventional shale shakers have been historically designed to separate all solids above a chosen size the industry has been required to use sequential screening with multiple machines running in series or to adopt a new design of shale shaker such as the AX1 machine manufactured by Axiom Process Limited to allow solids of an undesirable size to be separated while returning solids of a desirable size to the mud system. The separation of solids of a desirable size and the return of these solids to the mud system is generally referred to as “Sized Material Retention”. Sized Material Retention will typically (but is not limited to) aim to retain solids in a range between 400 and 90 microns in diameter—but these solids may be either larger or smaller depending upon the specific application.

Despite the advent of improved screening machines such as high capacity, multi deck shale shakers to improve the throughput, and ability to recycle solids of selected sizes, there is still a need for yet further improved equipment and methods to allow increased separation efficiency and/or modes of operation.

### DESCRIPTION OF THE INVENTION

According to a first aspect the present invention provides a screen assembly for use in a vibratory screening machine, the screen assembly comprising first and second screen units spaced apart by a support frame interposed between the screen units;
wherein said first and second screen units each comprise a screen panel including screening material; the screen panel of the first screen unit is disposed, in use, across a top side of the support frame and the screen panel of the second screen unit is disposed, in use across an underside of the support frame; and
wherein the support frame and second screen unit define at least one channel formed and arranged so that solids collected by the second screen unit may be transported off an end of the screen unit by the vibratory action of a said vibratory screening machine.

The vibratory screening machine making use of the screen assembly may be for example a shale shaker. However the screen assemblies may be used in a wide variety of vibratory screening machines. In use the screen assembly may be horizontal or may be inclined to some extent. For example, in a typical shale shaker, the screen assemblies employed are inclined so that the liquid and solids feed supplied for the separation process forms a pool or “pond” at one end with a “beach” of solids, screened from the liquid, forming on the screen at the edge of the pond. The separated solids are walked up the screens by the vibratory action of the shaker and discharged from the end of the screen assembly distal to the pond. Alternative arrangements may be employed utilising screens that are substantially horizontal or sloping away from the end of the screen supplied with the flow of solids or solids and liquid, to be separated.

Typically, the apertures in the first screen panel, for the passage of solids below a selected size (and fluid if present) are larger than the apertures in the second screen panel, which allow solids below a smaller selected size to pass through. However they may be provided with apertures of the same size. For example, experience shows that when screening a solids and liquids mixture through screening material, such as woven wire mesh, a second screening through screening material of the same aperture size (same mesh size for example) will result in a further solids fraction being removed from the mixture. i.e. screening on a panel of a given aperture or mesh size is not absolute, therefore a further screening using the same aperture or mesh size can be used to obtain a further fraction of solid product.

When in use the first and second screen panels of the corresponding screen units are generally held in close contact with the support frame, for example they are held in tension across and in contact with the support frame as shown hereafter and with reference to specific examples.

The screen assembly may be provided with a third or even further screen units, with each screen unit spaced apart from the preceding by a further support frame.

The screen panels of the screen units may comprise, or consist of, or consist essentially of a sheet or more than one sheet of a screening material, suitable for the screening task envisaged. For example woven wire mesh manufactured from stainless steel, bronze, high tensile steel, or other suitable metal or metal alloys, a suitable plastic or combination of plastics and other materials with apertures for the passage of undersized material and fluid. Alternatively screening material can be, but not limited to, wedge wire, moulded plastic, perforated metal or plastic. The screening material may be arranged in single or multiple layers according to the aperture size, material type and duty required. If multiple layers are used they are normally arranged such that the upper layer, that will be the first to be contacted by the solid and fluid, and is normally the element with the smallest aperture size, is mounted over progressively stronger elements of increasing aperture size. The second and subsequent layers may be selected not only to provide support for upper layers but to interact with the upper layer so as to reduce the tendency of the upper layer of screening material to suffer from plugging, by particles near to the mesh aperture size.

The screen panels may be planar (in use) or substantially planar in use or they may be for example in the form of a corrugated sheet such as is known in the art. For some applications the screen units may comprise or consist essentially of a mesh panel, for example of a woven wire mesh or a plastic mesh such as mentioned above.

Screen panels may be provided in the form of a pre-tensioned mesh layer or layers of mesh fitted to an apertured plate such as are known in use with shale shakers. For example as described in WO03/013690.

In general where screen panels are of an apertured plate with a mesh attached the mesh may be fitted either above or below the apertured plate (with reference to the in use orientation). Where a mesh is fitted below an apertured plate the plate may act as a baffle, to control fluid and solids flow, through the screen and to control screened solids movement off the plate. Typically the mesh or layers of mesh are fitted above the apertured plates (considered in the in use orientation) for both the first and second screen units

The screen units may be screen panels provided with first and second support members formed and arranged for clamping in use, to the support frame. For example, in the basket of a vibratory screening machine such as a shale shaker, for example in the manner described in WO03/013690.

As described therein and hereafter with reference to some examples, the screen units may be clamped into contact with the support frame and may be tensioned across it when the screen assembly is fitted to the vibratory screening machine. In such examples the support frame may be detachable from vibratory screening machine or may be permanently secured to the machine, for example permanently secured in the basket of a shale shaker.

Alternatively the screen units may be fixed to the support frame, for example by bonding by adhesive or by welding. Bonding may also be by fusing together by melting. For example a wire mesh cloth as screen panel or one layer of a screen panel may be fused to a plastic or plastic coated support frame, softened by heat. Alternative fixings could include the use of fastenings such as bolts or rivets, for example passing through support members of the screen units and into or through the support frame.

Where the screen units are fixed to the support frame before fitting in a vibratory screening machine the complete screen assembly can be considered a screen assembly cassette comprising two screening surfaces, one above the other that can be conveniently fitted to a screening machine in a unitary fashion and removed and replaced in a similar way.

It will be appreciated that the support frame may be of any suitable material known in the vibratory screen apparatus art including but not limited to plastics such as glass reinforced polyester and/or polyethylene, polypropylene, polyamide etc. or a blend thereof, metal such as galvanised steel or advantageously stainless steel.

The support frame can take several different forms. In most instances the support frame will have apertures or channels providing pathways allowing solid particles and fluid (the filtrate), to pass through the first screen unit to reach, more or less directly, the screening surface of the second screen unit.

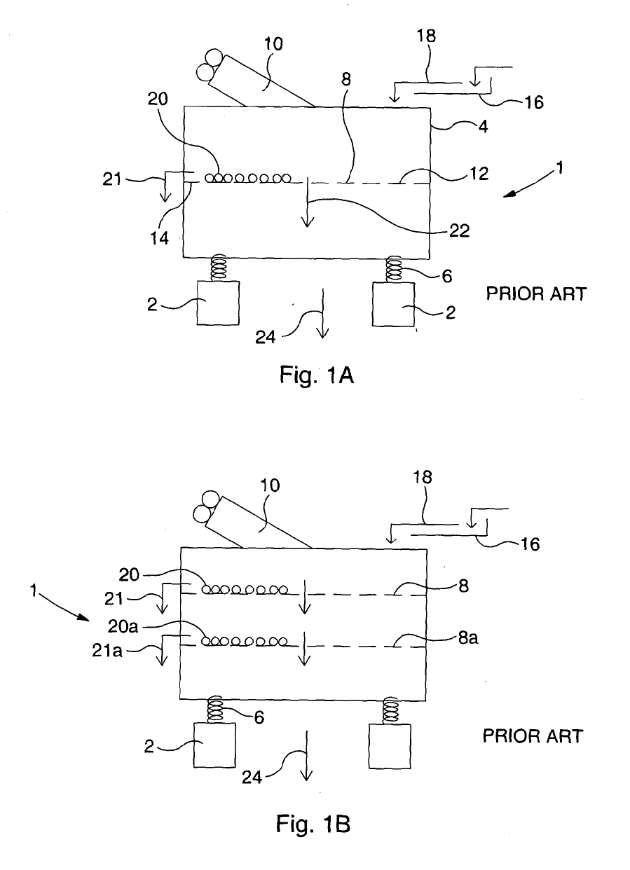

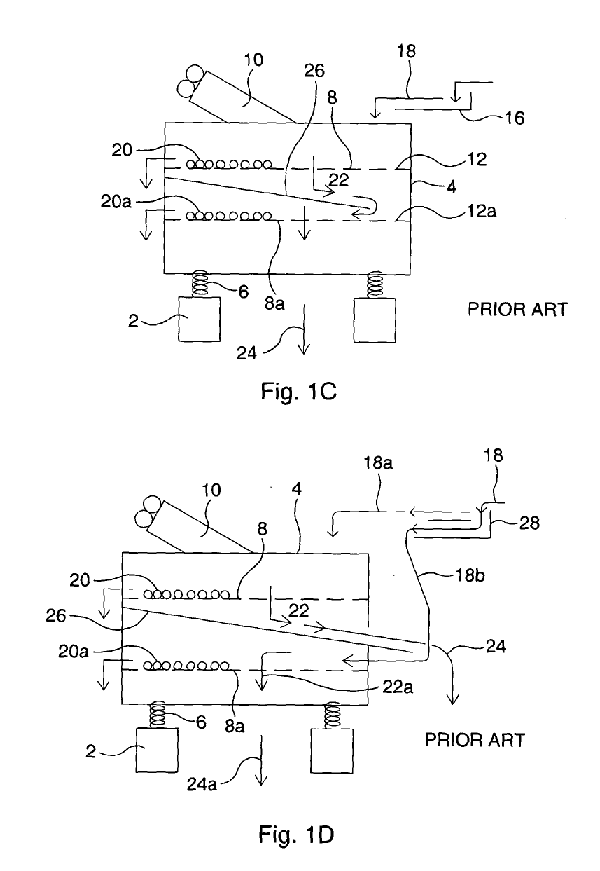

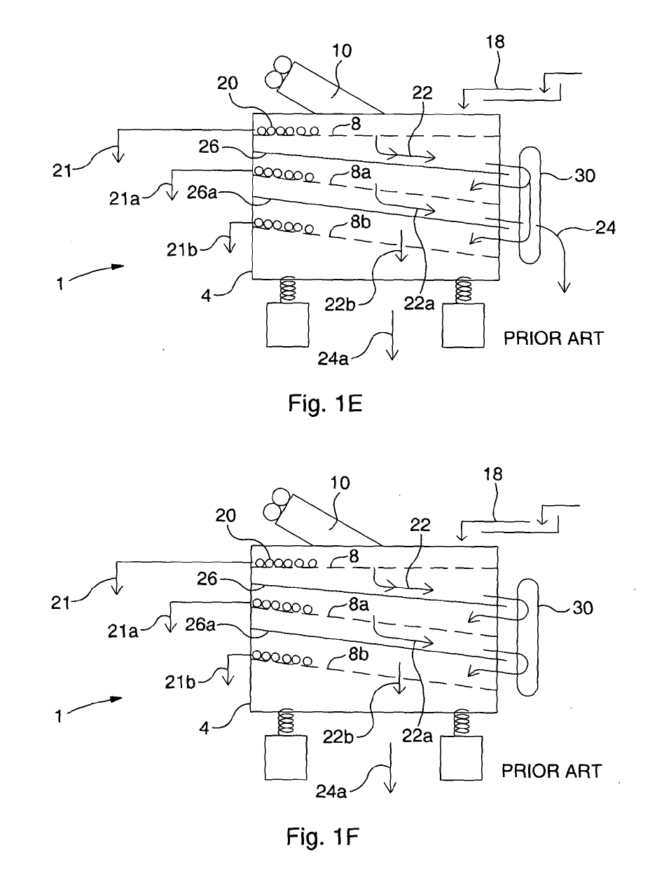

Alternatively and for use in shale shakers the support frame may be provided with flow back means incorporated between the first and second screen units. This can allow a single screen assembly of the invention to function in a comparable fashion to two conventional screen assemblies fitted in a shale shaker with a flowback pan or flow directing tray fitted between the assemblies as described hereafter and with reference to FIG. 1C.

Further items that may be fitted between the first and second screen units include, but are not limited to, baffles to control the flow of fluid between the screen layers, or to interrupt the natural flow of fluid thus controlling blinding of the screen panel of the second screen unit and/or solids transportation. For some applications it is convenient to provide sealing or closure panels, or other means, to ‘blank off’ one or more ends of the second screen unit. This blanking off acts to prevent solids screened by the second screen unit or filtrate from the first screen unit (that has not yet been processed by the second screen unit), moving off the second screen unit in an undesired direction. i.e. the screen assembly can be arranged to avoid undesired leakage by provision of appropriate blanking off panels or seals.

The support frame may be a rigid or semi-rigid structure, for example a rectangular box like structure that may itself be constructed of a plurality of separate boxes arranged and attached to each other in a side by side manner to provide rectangular (in plan) top and undersides for the attachment of the first and second screen units. Alternatives include a zig-zag or corrugated sheet of a rigid or semi-rigid material, with apertures provided to allow passage of filtrate. Further alternatives include a support frame of interconnected members such as rods or a combination of rods and plates formed to hold the first and second screen units spaced apart.

More generally the support frame comprises frame elements disposed between the screen units to provide support and ensure the desired spacing apart. Typically the support frame may comprise a plurality of spaced apart (typically parallel) elongate elements running from one side of a screen assembly to the other or the support frame may comprise a plurality of frame elements disposed across the screen assembly, and between the first and second screen units. For example a support frame may comprise spaced apart and parallel elongate first and second support frame elements defining opposed edges of a screen assembly. These first and second frame elements may conveniently be used for fixing or clamping the screen assembly into a vibratory screening machine such as a shale shaker. The support frame may then further comprise one or more additional frame elements disposed between the first and second frame elements and between the first and second screen units. These additional frame elements may be a plurality of spaced apart elongate support frame elements running parallel with and/or transverse to the first and second frame elements.

Yet further alternatives include the provision of screen modules which are arranged together to form the screen assembly in use. The screen modules each includes first and second screen units and support frame elements. When located together in a vibratory screening machine the modules combine to form a screen assembly. For example the modules may be rectangular box like structures, each having a top and bottom surface that takes the form of an apertured plate to which is attached a screening material such as a wire mesh. These top and bottom surfaces with mesh attached constitute the first and second screen units, with sides of the box connecting the top and bottom surfaces being the support frame (support frame elements) interposed between the two screen units. A screen module constitutes a further aspect of the present invention and its use to form a screen assembly a yet further aspect.

Thus the present invention provides a screen module for use in forming a screen assembly for a vibratory screening machine said screen module comprising first and second screen units spaced apart by a support frame interposed between the screen units;
wherein said first and second screen units each comprise a screen panel including screening material; the screen panel of the first screen unit is disposed, in use, across a top side of the support frame and the screen panel of the second screen unit is disposed, in use across an underside of the support frame; and
wherein the support frame and second screen unit define at least one channel formed and arranged so that solids collected by the second screen unit may be transported off an end of the screen unit by the vibratory action of a said vibratory screening machine.

The modules may for example take the form of rectangular tube or box sections with apertured top and bottom sides that act as apertured plates for the first and second screen units. The screening material may take the form of mesh or other suitable screening material attached, pre-tensioned, to the top and bottom sides of the box section.

A screen assembly can be formed comprising a plurality of the modules attached one to another to form screening surfaces (i.e. the screen panels of first screen units form an upper screening surface and the screen panels of second screen units form a lower screening surface).

The plurality of modules may be attached one to another in various ways to form a screen assembly.

They may be bonded together, for example by adhesive or welding to form an assembly that can then be mounted in a vibratory screening machine. Or they may be bonded one to another in situ, in a vibratory screening machine.

They may be secured one to another by permanent or releasable fastenings such as rivets or nuts and bolts. This may be done to form an assembly that can then be mounted in a vibratory screening machine, or the modules may be fitted one after another into a vibratory screening machine to form the assembly.

The modules may be fixed into a frame, permanently or releasably to constitute a screen assembly, before being fitted into a vibratory screening machine. Fixing to the frame may be by bonding or by fastening means such as described above.

Advantageously the modules may be placed in a vibratory screening machine provided with a suitable clamping system that holds the modules together as a screen assembly when they are placed in a vibratory screening machine. For example a plurality of modules may be placed alongside each other, resting on a suitable support or supports and then held firmly one against each other by a clamping system comprising inflatable tubing as described hereafter in more detail with reference to a specific embodiment. Other clamping techniques employed in a clamping system may include the use of one or more of hydraulic rams, bolts, mechanical wedges and pneumatic cylinders; to provide a clamping force.

Where the modules are clamped together to form a screen assembly they may conveniently be provided with engagement means that nest or interlock. For example projections on one module support frame that fit into depressions or holes in a neighbouring module support frame. For further example shaped modules that nest together when laid alongside each other (e.g. convex and corresponding concave sides of support frames or projecting edges and corresponding chamfered edges of support frames. Such means can assist in locating modules before the clamping force is applied and can aid in ensuring correct location of each module in the clamped together assembly.

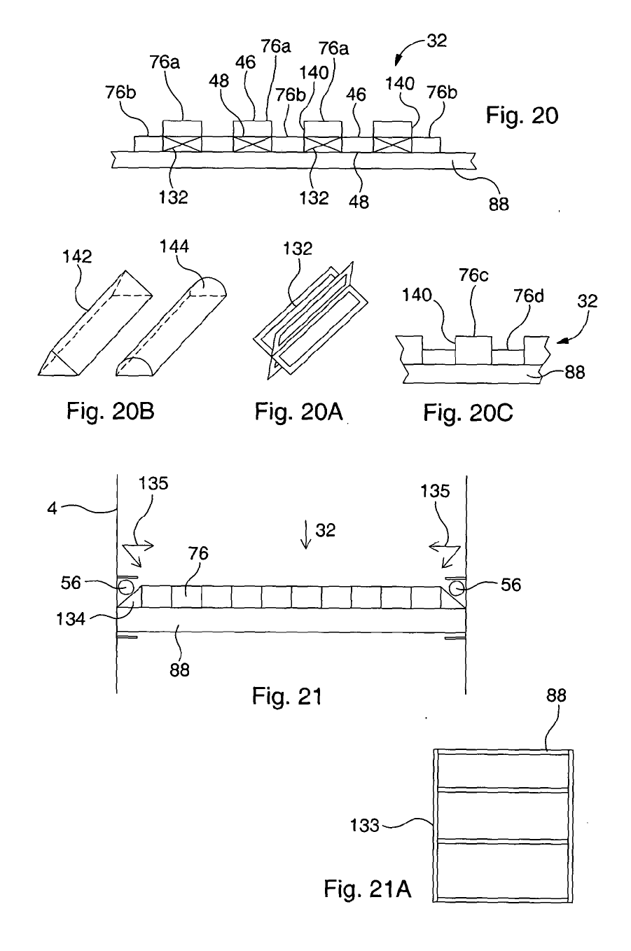

As yet further alternative modules may be attached one to another with the use of support structures. In some cases adjacent modules (e.g. elongate rectangular box modules) may not be placed in a side by side relationship on the same level to form a screen assembly. The modules may be connected with the use of additional support elements (for example longitudinal support elements) to form an array of alternating upper and lower modules. The upper modules are each attached on top of an additional support element and the lower modules are spaced by being attached to either side of the additional support elements. With such an arrangement the upper modules may be provided with additional screening surface area, for example along the sides of a rectangular box like module (see for example the embodiment of FIG. 20 discussed hereafter). With an assembly in the form of an array of alternating upper and lower modules various shapes of modules may be used, for example elongate rectangular boxes, elongate triangular prisms, elongate half cylinder or other complex shapes.

An alternative means of providing a screen assembly with an upper (and/or lower) screening surface of varying height is to provide screen modules having differing height in an assembly. For example elongate rectangular box modules of differing cross section height can be attached or clamped together to form a screen assembly. Such an assembly may for example be arranged with all the second screen units of the modules on the substantially the same plane to provide a planar or substantially planar lower screening surface. The upper screening surface will then have screening surfaces of differing height provided by the differing heights of the modules. Alternating taller and shorter modules may be employed to make such a screen assembly. The taller modules may have additional screening surface area provided along the sides of the box, at above the height of the shorter modules.

It will be appreciated that the screen modules may in some circumstances be fitted only with one screen unit, either the first or the second. Alternatively the screening material may be omitted from the screen panel. Thus an assembly of the screen modules described above may provide only one screening surface. Although this approach provides only one screening stage from the assembly the advantages of the modular approach remain—ease of manufacture and assembly; and ease of repair or replacement.

The modular approach may therefore be used where only one screening surface is required in an assembly formed from modules. Thus the present invention also provides a screen module for use in forming a screen assembly for a vibratory screening machine said screen module comprising a screen unit mounted on a support frame wherein said screen unit comprises a screen panel including screening material; wherein the screen panel of the screen unit is disposed, in use, across a top side or a bottom side of the support frame. A plurality of these screen modules may be attached together to form a screen assembly in any of the ways described above in respect of screen modules having first and second screen units (two screening surfaces). These modules may take similar forms to those described above for modules including two screen units, e.g. elongate rectangular box structures.

In conventional screen assemblies having one screen unit on (on top of) a support frame, such as are used in shale shakers, the screen panel of the screen units employed are often shaped or tensioned over a support frame that provides an arcuate shape to the panel, to form a so called ‘crown deck’. The crown deck arrangement aids in keeping the panel of the screen unit rigid during vibratory motion and assists in keeping the support frame in close contact with the panel, avoiding damage caused by excessive relative motion between the two.

Screen assemblies of the present invention can make use of the benefits of a crown deck arrangement in various ways as described hereafter with reference to examples. In particular the support frame may include frame elements having arcuate support surfaces for either one or both of the first and second screen units or may include elongate frame elements of varying height from an edge of the support frame to the centre and then to the opposite edge, thereby providing an arcuate form over which the screen panel of the screen unit is disposed. Thus the screen assembly of the present invention may have a crown deck formed by either or both of the first and second screen units. A crown deck formed with the second screen unit may be inverted from the convention with the central part of the screen lower in use than the edges.

The screen assemblies described herein can provide several advantages. In conventional arrangements screen assemblies for vibratory screening machines comprise a panel of one or more layers of mesh or other screening material, supported on top of a base or support frame in use. With the present invention only one support frame is required per pair of screen units. Although as shown hereafter by example a further support frame may be located below the screen assembly of the invention it is not a requirement in many instances.

By providing a support frame interposed between the first and second screen units, each screen unit can operate to provide a separate screening stage, with solids retained by the first and second stages discharged from an end of each screen unit, allowing the option of combining them or directing them to different locations for subsequent disposal or reuse.

Advantageously and as illustrated hereafter with reference to an example, the end of the first screen unit from which screened solids are discharged extends in a horizontal (in use) direction further than the corresponding end of the second screen unit. This arrangement has the effect that as solids are discharged from the ends of the two screen units, the solids stream from the first (i.e. upper) screen unit can be allowed to fall vertically without interfering with the solids stream discharged from the second (lower) screen unit. This aids separate collection of each of the solids streams as they can, for example, each be allowed to fall vertically off the end or edge of the screen unit into adjacent collection chutes or other conveyance means for subsequent, independent, further processing, disposal or recycle.

These two separate screening stages can be carried out in a very space efficient manner. Little height is required in comparison with conventional stacking of screen assemblies as discussed below. Furthermore the screen assembly of the invention can make use of conventional, substantially flat panels, such as mesh supported on an apertured support plate, as the panels are spaced by the support frame. There is no requirement to make use of panels that are more complex to manufacture, such as corrugated panels, to achieve spacing between panels for solids transport, such as envisaged in U.S. Pat. No. 6,186,337 where corrugations in screen panels are used to define channels for the passage of screened solids.

Where multiple screening processes are to be operated a stack of such assemblies, each with its own support frame is provided to allow for example successive screening of a drilling mud, through meshes of increasingly finer aperture (generally called Progressive Screening); or for further example parallel processing through two or more screen assemblies in the stack. The more superposed screen assemblies in the stack the greater the height (e.g. of a shale shaker basket) required to accommodate them. Where space is at a premium the number of conventional screen assemblies that can be employed in a stack is limited.

The screen assemblies of the present invention have the advantage that two screening operations can be carried out, one by each screen unit, per support frame required.

Thus the screen assemblies of the present invention can carry out two screening operations whilst only taking up a similar height in a screening machine to that of a conventional assembly that carries out one screening operation. The assembly of the invention allows many different options in terms of the possible operational use of a vibratory screening machine, in particular shale shakers, that can only be achieved with conventional apparatus by using additional screening machines and/or providing a machine with increased height.

As a screen assembly of the invention provides two screen units mounted in relative close proximity by reason of the shared support frame, they can be used in a screening operation such that the screens act together to allow Sized Material Retention or Progressive screening to be achieved, in a more space efficient manner.

Progressive screening may be used with or without Sized Material Recovery and can be an advantage even when providing only solids removal. It has been recognised that fine meshes can suffer short life when used to separate a wide range of solids sizes. Where a feed material contains a wide range of solids it can be advantageous to progressively separate increasingly finer sizes of solids with progressively finer mesh screens. Thus a feed is passed through a first screen to remove an initial size fraction and subsequently through progressively fine screens, each screen separating an element of the total solids to be removed. Through this process the physical load and wear on finer meshes is reduced and the screen life of fine meshes, that are generally more expensive than coarser meshes, can be extended and in an extreme case can allow fine mesh operation to become economic where it would have not been economic had progressive screening not been applied. Furthermore separation efficiency can be increased using progressive screening. By making use of screen assemblies of the present invention progressive screening is possible even when the machine has only one deck for fitting screen assemblies.

Further advantages available with the screen assembly of the invention can include the following;

When used for normal solids removal and or in combination with Sized Material Retention the screen life can be extended. As described above where progressive sized meshes or even the same sized meshes are to remove a range of solids, the screen life of the finer meshes is normally extended.

The screen assemblies can be adapted to meet varying applications. Upper and lower mesh sizes of an assembly can be changed to meet widely varying applications.

The screen assemblies can generally be manufactured with existing manufacturing techniques and technology.

The screen assemblies can be fitted to existing machines to allow those machines to achieve Sized Material Retention and/or use Progressive Screening.

New machines can be designed that are increasingly compact, or physically smaller, or larger, while offering less, more or similar numbers of screening decks, with but not limited to, any one of or any combination of, higher process capacity, longer screen life, improved operating economics, flexibility of operation, simplicity of operation and increased separation efficiency.

New machines can be designed that can be single or multiple deck machines with either parallel, or parallel and series or any combination of both operating options. When used with the screen assemblies they can flexibly perform multiple combinations of Sized Material Retention and Progressive Screening as may be chosen by the operator and may be appropriate for any application.

A further advantage of the invention can be the reduction of the total number of screen assemblies held in inventory at the machine's operation location. The reduction in inventory results from the storage of only one screen assembly (having first and second screen units) compared to two previously. Inventory can also be reduced as a result of the increased screen life that can be obtained through Progressive Screening, as described above.

The screen assemblies can be repaired (where a screen is damaged) using conventional means such as repair plugs as marketed by Axiom Process Limited.

A wide range of mesh sizes, may be employed including the same or different mesh size for first and second screen units.

In addition to the option of providing flow back means between the first and second screen units, further suitable flow control means may be incorporated between the screen units including, but not limited to, baffles to control the flow of fluid between the screen layers, interrupt the natural flow of fluid and affect blinding and or solids transportation.

Two or more or any combination of number of screen units may be provided in a screen assembly as is appropriate for the space in which the assembly may be required to operate or is designed to operate.

It is possible to stack the screen assemblies immediately above one another (in contact) or spaced such that a high number of screens are located within a small height and as appropriate for the application for which the screens are to be used.

The screen assemblies may be used with any combination of conventional single layer screens in either existing machines or in new designs of machines.

Any combination of different shaped screen configurations such as, but not limited to, conventional flat or curved screens, corrugated screens, or pyramid screens may be employed on the first and second screen units.

The screen assemblies may be used at any operating angle, such that the assembly may be operated while mounted at any combination of horizontal, downward sloping, sideways sloping or upward sloping angles. Screens may be mounted such that solids traverse the screen longitudinally from the input end to the discharge end or laterally from the centre of a machine to the side of a machine.

The screen assemblies may be used with vibratory screening machines using any combination vibratory of motion or screen type.

According to a further aspect the present invention provides methods for screening a solids mixture or a solids and liquid mixture the method comprising:
a) providing: a screen assembly for use in a vibratory screening machine, the screen assembly comprising first and second screen units spaced apart by a support frame interposed between the screen units; wherein said first and second screen units each comprise a screen panel of screening material, the screen panel of the first screen unit is disposed, in use, across a top side of the support frame and the screen panel of the second screen unit is disposed, in use across an underside of the support frame; and wherein the support frame and second screen unit define at least one channel formed and arranged so that solids collected by the second screen unit may be transported off an end of the screen unit by the vibratory action of a said vibratory screening machine;
b) installing the screen assembly in a vibratory screening machine;
c) screening a said solids mixture or a solids and liquid mixture through the screen assembly installed in the vibratory screening machine.

The method will include at least two screening steps, one through each screen unit. However more screening steps may be carried out by carrying out the method in a vibratory screening machine having further screen assemblies, either conventional or according to the present invention, installed. Examples are given hereafter and with reference to specific embodiments.

The method may include recovering at least one selected solids stream from a screening step for the purpose of any one of recycle, reuse and further processing.

Where a solids and liquid mixture is screened, the method may further include directing at least one solids stream produced by a screening step carried out in the machine back into a screened fluid product from the machine.

The method may also allow combining at least two solids streams produced from selected screening steps for further processing or use.

The method is of particular benefit when carrying out progressive screening as it allows more screening steps to be carried out for a given size of screening machine.

### DESCRIPTION OF SOME EMBODIMENTS BY WAY OF EXAMPLE

Further preferred features and advantages of the invention will appear from the following detailed description given by way of example of some preferred embodiments illustrated with reference to the accompanying drawings in which:

FIGS. 1A to 1F illustrate prior art screening operations;

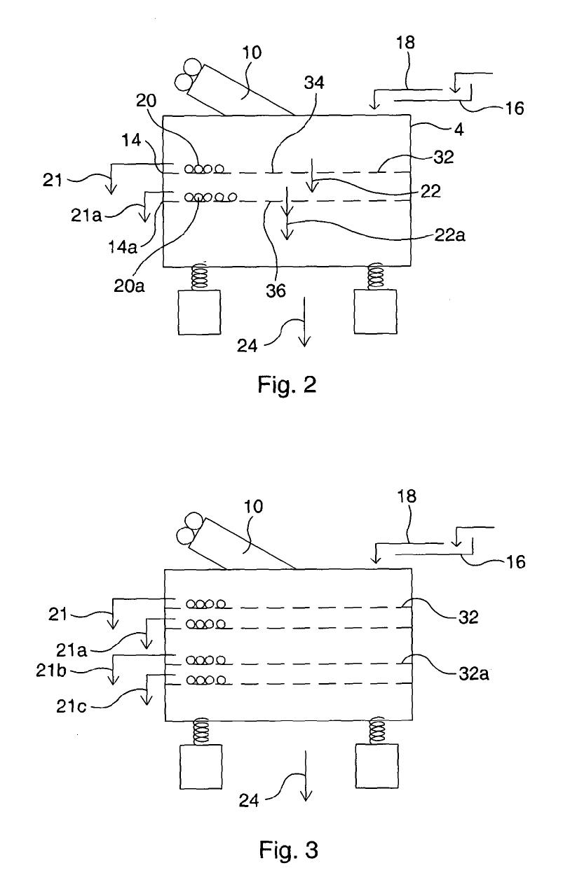

FIGS. 2 to 7 illustrate screening operations using screen assemblies of the invention;

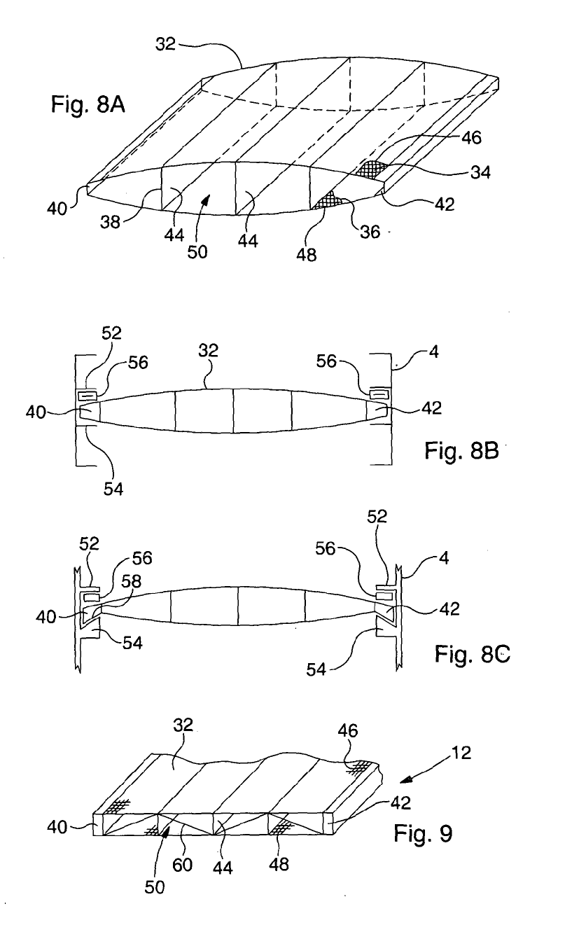

FIGS. 8A to 8C illustrate screen assemblies of the invention;

FIG. 9 illustrates another screen assembly of the invention;

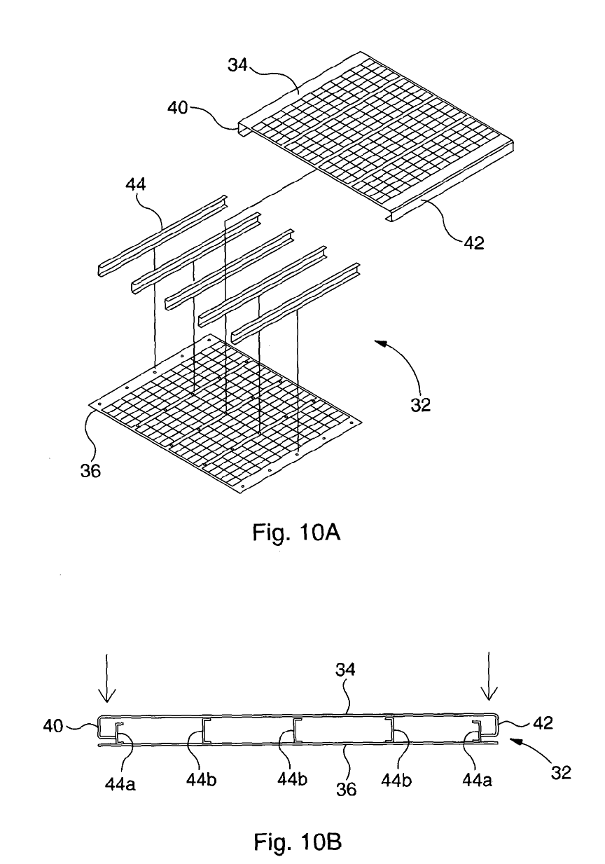

FIGS. 10A, 10B illustrate another screen assembly of the invention;

FIG. 11 illustrates another screen assembly of the invention;

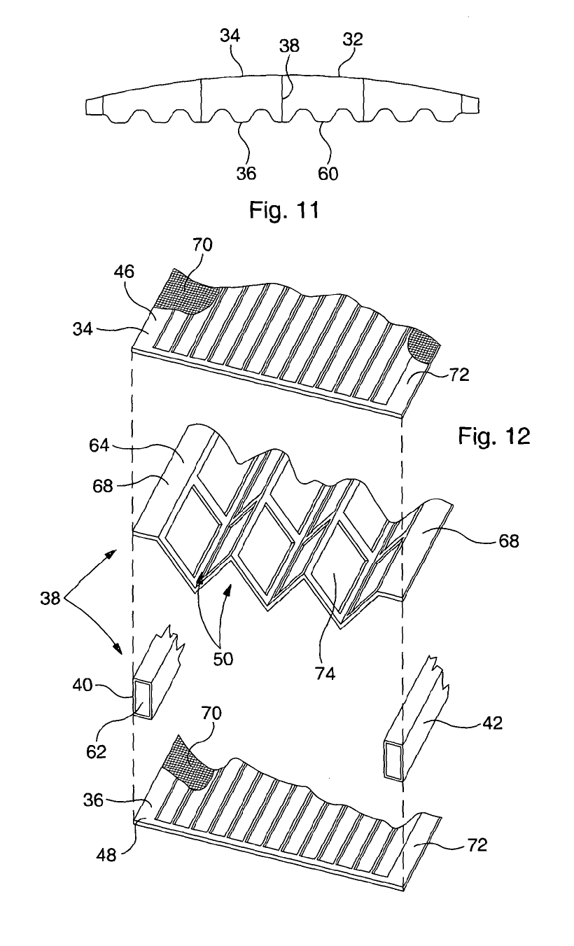

FIG. 12 illustrates another screen assembly of the invention;

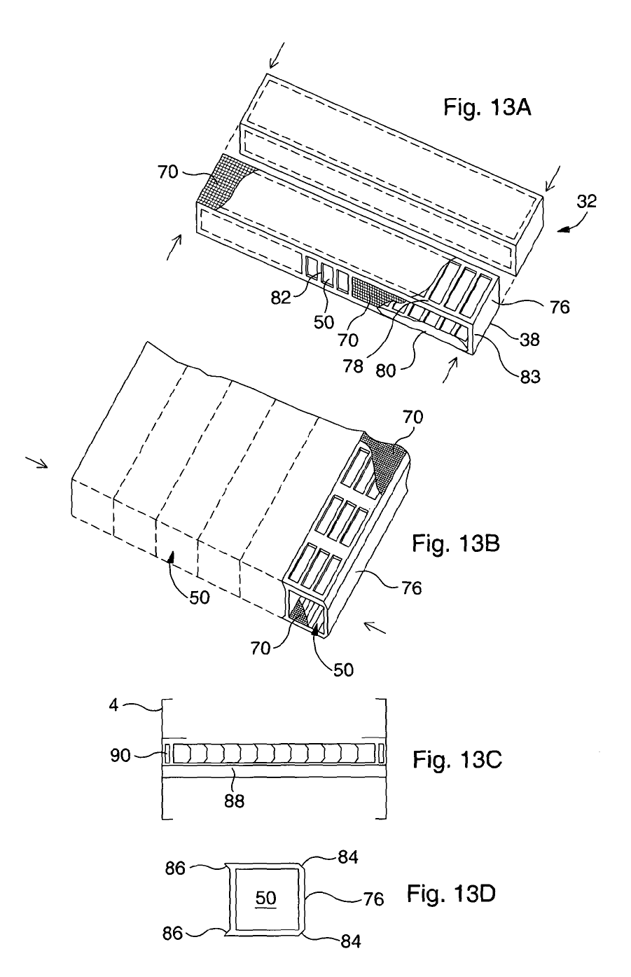

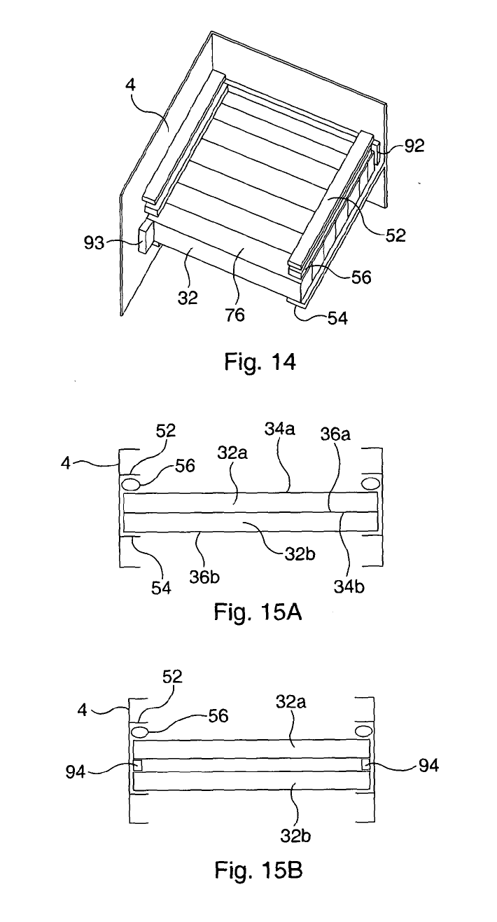

FIGS. 13A to 13D and 14 illustrate further screen assemblies of the invention, including box section assemblies and modules;

FIG. 15 illustrate screening operations using screen assemblies of the invention;

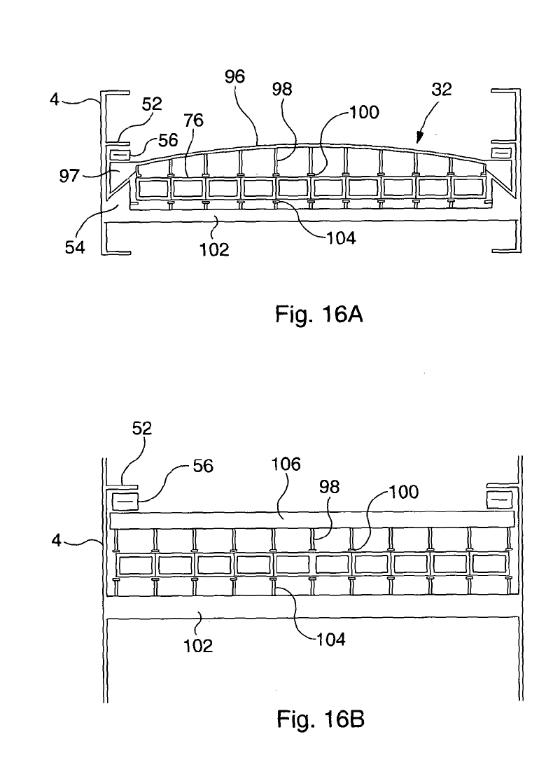

FIG. 16 illustrate clamping modular screen assemblies of the invention to a basket;

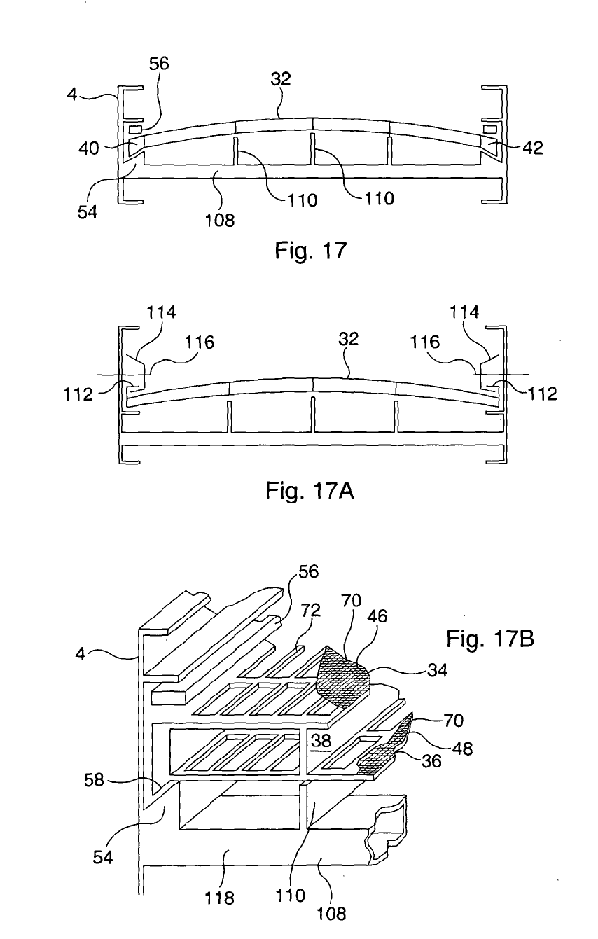

FIG. 17 illustrate clamping screen assemblies to a basket;

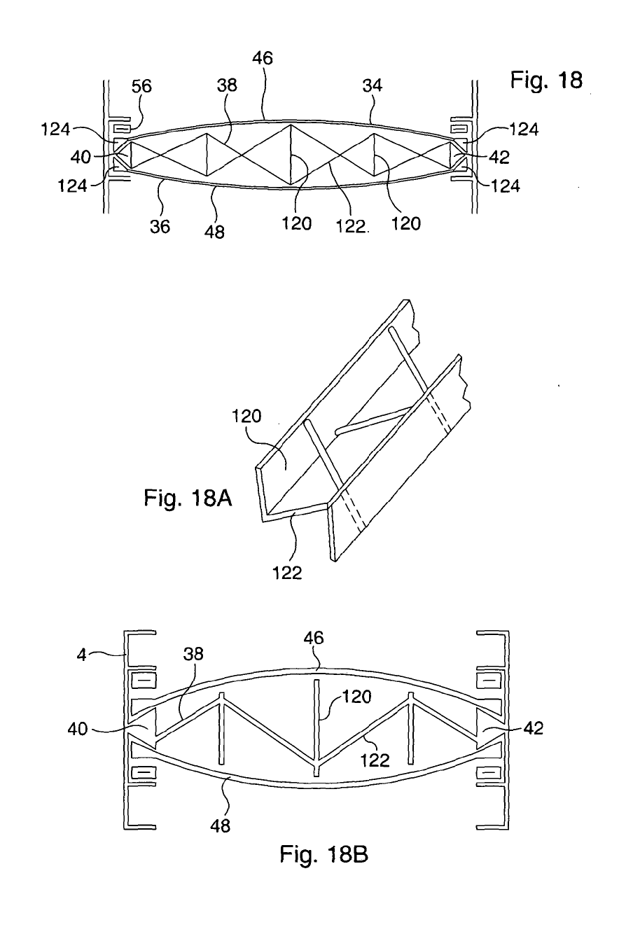

FIG. 18 illustrate yet further screen assemblies and their clamping to a basket;

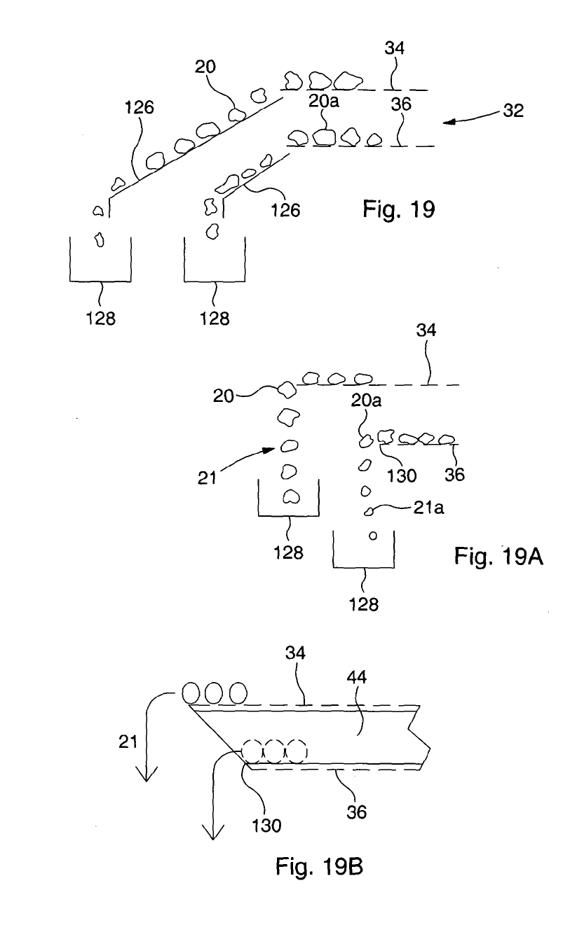

FIG. 19 illustrate details of the use of screen assemblies of the invention;

FIG. 20 illustrate a yet further screen assembly; and

FIG. 21 illustrate a method of clamping a modular screen assembly to a basket.

### PRIOR ART SCREENING APPARATUS AND OPERATIONS

FIGS. 1A to 1F illustrate schematically the operation of various types of known (prior art) vibratory screening machines (shale shakers are shown in these examples) in use with conventional screen assemblies. The machines illustrated have varying numbers of superposed decks, i.e locations for fitting screen assemblies.

FIG. 1A shows a single deck shale shaker 1. The shale shaker 1 has a base 2 on which is mounted a vibratory basket 4 by means of springs or rubber mounts 6. A screen assembly 8, indicated by a dashed line, is shown in use. Vibration means 10 is mounted on top of the basket 4 to provide the vibratory motion.

Typically the screen assembly 8 would be of a screen panel of a wire mesh or meshes tensioned across a suitable support frame. In many operations a screen panel of pre-tensioned wire mesh or meshes mounted on an apertured support plate is clamped and tensioned across a support frame. Typically the support frame is shaped to form the screen panel into a crown deck.

Although the screen assembly 8 as indicated in this figure as being horizontal by the dashed line, it will be appreciated that in many cases the screen assembly will be at an inclined angle, with a lower end 12 and a slightly higher end 14. In all the figures shown herein the screen assemblies indicated may be horizontal or, more typically at an inclined angle from the horizontal as is well known in the art. A pool or ‘pond’ of fluid and solids being screened forms on the lower end 12. At an intermediate point on the screen assembly the pond ends and the remaining higher end of the screen is described as the ‘beach’ where screened solids are walked up the screen panel to the discharge point (the upper end 14) by the action of the vibratory means 10, with residual fluid on the solids continuing to drain through the screen panel. In other screening machines, not employing a pool system with solids walked up the screen, the screen assembly may be inclined but the vibratory action is provided to aid gravity in encouraging screened solids to move down and off a lower end of the screen.

Not shown in this example (but see FIG. 1C) the basket may also be provided with a flow directing tray situated beneath the screen assembly 8.

In use of the shale shaker 1 a used drilling mud fluid including drill cuttings 18 (or other fluid containing solids to be separated off) is input to the basket 4 via a conduit 16 acting as a feed chute. Solids 20 of above the aperture size of the screen assembly 8 are separated off by the screen panel of the screen assembly 8 and conveyed by the vibratory action of the vibration means 10, to the end of 14 of the screen assembly 8 from where they can be discharged (with the discharged solids stream 21 indicated by the downwards arrow) for disposal or further processing. Meanwhile the fluid and solids below the aperture size of the screen panel of the screen assembly 8 pass through as indicated by arrow 22. The cleaned fluid (filtrate) 24 often collected in the sump (not shown) of the shale shaker 1 can then be directed to a tank for storage and reuse of for further processing before re-use.

FIG. 1B shows a similar shale shaker 1 to that of FIG. 1A but fitted with two superposed screening decks each fitted with a screen assembly 8,8a. Upper screen assembly 8 has a screen panel of larger aperture than that of lower screen assembly 8a. The operation of shale shaker 1 is similar to that of the machine shown in FIG. 1A, except that both screen assemblies 8 and 8a remove solids 20 and 20a (with the discharged solids streams 21,21a indicated by the downwards pointing arrows) of progressively smaller size as the fluid passes through. Thus the cleaned fluid 24 has been subject to two stages of progressive screening (series processing though screens of decreasing aperture size). If desired the differently sized solids 20 and 20a may be collected separately by use of appropriate outlets and associated conduits, conveyors and/or collecting bins. For example the solids 20a collected on the lower screen assembly 8a will be of a size range between that of the apertures of the screen panels of the upper and lower screen assemblies.

FIG. 1C shows a similar operation to that of FIG. 1B except that a fluid directing tray or flowback pan 26 is fitted between the two screen assemblies 8,8a. This arrangement has the benefit that the fluid 22 (filtrate) passing through the upper screen assembly 8 is directed to the (usually lower) end 12a of the lower screen assembly 8a rather than over most or its entire screening surface. The flowback pan 26 prevents the solids 20a progressing towards discharge from the lower screen assembly 8a being rewetted by fluid 22 and thus losing filtration and separation efficiency. Flowback pans are routinely used when the screen assemblies are inclined as discussed above with respect to FIG. 1A, providing a pond and beach arrangement.

FIG. 1D shows the same shale shaker 1 as in FIG. 1C but with a different feed arrangement. A static flow divider 28 splits the input fluid/solids mixture 18 into two substantially equal parts 18a,18b which are fed separately to the upper and lower screen assemblies 8,8a. The flowback pan 26 collects the fluid 22 (filtrate) from the upper screen assembly which is not directed onto the lower screen assembly 8a but is directed out of the shaker 1 as indicated by arrow 24 (or alternatively past lower screen assembly 8a to a sump of the shaker 1, not shown, and then subsequently out of the shaker). The fluid/solids mixture 18b is directed to the lower screen assembly 8a and processed there with the filtrate 22a directed out of the shaker as shown by arrow 24a (again this may be via a sump of the shaker). Thus the machine of FIG. 1D is operating in parallel mode with each screen assembly carrying out a single independent screening stage. The shale shaker 1 is carrying out a single screening operation but with a screening area twice that of a single deck machine (FIG. 1A) having a basket 4 of the same size mounting a single, similarly sized, screen assembly 8.

FIG. 1E shows a shale shaker 1 similar to that of FIG. 1D but this machine has three decks each carrying a screen assembly 8,8a,8b. The stack of screen assemblies 8,8a,8b is provided with flowback pans 26,26a between each pair of screen assemblies. A different flow distribution system is employed to permit parallel or series (FIG. 1F) processing. In this example the feed 18 is all directed to the upper screen assembly 8, which provides relatively coarse screening (the screen panel has relatively large apertures). The filtrate 22 is directed via the flowback pan 26 to a flow distributor 30 mounted to the basket 4. Examples of suitable flow distributors are described in WO2004/110589. The flow distributor is set to take the filtrate 22 from the upper screen assembly and divide it between the subsequent screen assemblies 8a, 8b. Parallel processing is then carried out in these screen assemblies, as discussed above for the arrangement of FIG. 1D, but with the benefit that larger sized solids 20 are removed from the fluid/solids mixture 18 before the parallel processing, which is normally done through screen panels with relatively small aperture or mesh sizes which are susceptible to damage by impact of larger sized particles.

FIG. 1F shows the same shale shaker 1 as that of FIG. 1E but with the flow distributor 30 set to provide progressive screening (series processing) through the three screen assemblies 8,8a,8b. The filtrate 22 from the upper screen assembly 8 is all sent to the second screen assembly 8a and the subsequent filtrate 22a is then all sent to the lowest screen assembly 8b. The screen panels will normally have decreasing aperture size to successively remove smaller and smaller solids as the fluid flows through the machine.

When using the machine shown in FIGS. 1E and 1F the solids produced may be combined as they are discharged or the different solids streams 21, 21a, 21b may be kept separate for reuse. An advantageous use of the series processing arrangement of FIG. 1F is when it is desired to recycle solids of a selected size range to a drilling mud fluid. By selecting the aperture size of the screen panels of the upper 8 and middle 8a screen assemblies the solids stream 21a discharged from the end of the middle screen assembly 8a will have particles falling within a selected size range. Thus the apparatus can selectively abstract particles of a selected size range, such as lost circulation material added to a drilling mud composition (and any other similar sized particles) and allow them to be recycled. The upper screen assembly 8 has removed undesired larger particles whilst at the same time the lower screen assembly 8b will filter out undesired finer particles from the cleaned drilling mud stream.

Examples of use of Screen Assemblies and Methods

FIG. 2 shows schematically a single deck shale shaker like the one shown in FIG. 1A but fitted with a screen assembly of the invention 32, with the first and second screen units 34, 36 indicated by the dashed lines. The support frame that they are attached to and that spaces them apart is not shown here but see FIGS. 8 to 19 for examples.

The feed 18 to the shaker 1 and the operation of the shaker is as shown in FIG. 1A except that two screening operations result, one from each of the first 34 and second 36 screen units. Thus a single deck shaker can provide two, progressive screening steps and produce two distinct solids streams 21,21a. If desired either one of these solids separated 20,20a (streams 21,21a) may be recovered for further processing and or re-use, for example in the filtrate 22a. These options may be obtained with minimal alteration to the shaker 1. Alternatively the solids produced 20, 20a may simply be combined as they are discharged from the machine, for example if they are to be disposed of.

Relatively simple adaptation of the screen assembly locating, securing and sealing systems in the basket 4 can be made to securely fit the screen assembly in place. Suitable solids collection as the solids 20 or 20a are discharged may be by a chute or other conduit, including a trough at the solids discharge edge 14 or 14a that directs the solids e.g. by simple gravity feed into the output cleaned fluid stream 24, that may be contained in a sump or a tank or flowing in a conduit.

FIG. 3 shows a two deck shale shaker 1 such as illustrated in FIG. 1B but fitted with two screen assemblies 32,32a of the invention. This arrangement provides four screening stages in a two deck machine. Progressive screening can thus be carried out though four increasingly finely apertured screen panels to produce a cleaned fluid stream 24. This allows a more efficient screening process to be carried out with each screen having a lesser solids burden to remove, which may permit faster throughput as well as providing reduced downtime due to damaged screens.

Recovery of solids from any one or from any combination of the four screens may be carried out, thus the cleaned mud stream 24 may have solids of one or more than one selected size range (from one or more of solids streams 21,21a,21b,21c) returned to it.

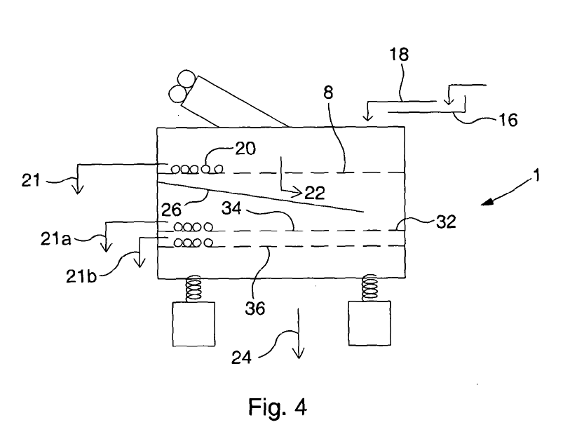

FIG. 4 shows the shale shaker of FIG. 1C in use but with a screen assembly 32 of the invention fitted to the lower deck position. Thus a two deck machine can carry out a three screen progressive screening operation. As before any one or more of the three solids streams 21, 21a, 21b produced may be recovered for recycle. Typically the solids stream 21a from the first screen unit 34 will be recycled as these solids 20a will have a size range between that of the apertures of the screen panel of the upper screen assembly 8 and that of the screen panel of the first screen unit 34. This method is thus equivalent to operating a conventional three screen arrangement in a three deck machine and including recovery of solids of a selected size (such as in FIG. 1F).

By way of an example, if fitted to the lower deck of a conventional two deck machine such as the VSM300 machine from National Oilwell Varco, the screen assembly 32 could be used as follows:

The top machine screening deck or scalping deck fitted with screen assembly 8 will process 100% of the flow returning from the oil well and remove the majority of solids above the desirable solids size range, allowing the majority of solids under the upper desirable size range to pass through the screen. Solids 20 separated by the upper screen deck would be rejected (stream 21). The fluid and solids passing through the upper screen deck will pass to the lower screen deck fitted with the screen assembly 32. The first (upper) screen unit 34 will have a mesh that will separate solids above the lower size range of the desirable solids to be retained in the mud system. Solids separated by the upper screen unit (stream 21a) will be reincorporated into the mud system (filtrate 24). The second screen unit 36 will be of a suitably fine mesh to separate as many of the remaining undesirable solids as possible, without removing excessive amounts of desirable solids, such as weighting material. Solids separated by the second screen unit 36 (stream 21b) are rejected.

Thus a two deck machine, that was not designed to deliver Sized Material Retention, can be made the achieve Sized Material Retention through the use of the screen assembly 32. Only minor modification to the machine is required to fit the assembly 32 with the addition of suitable solids collection and rejection means. Such an arrangement of chutes and conduits is normally not part of the machine itself. If Sized Material Retention is not required the arrangement shown still has the benefit of allowing Progressive Screening through three screens in a two deck machine.

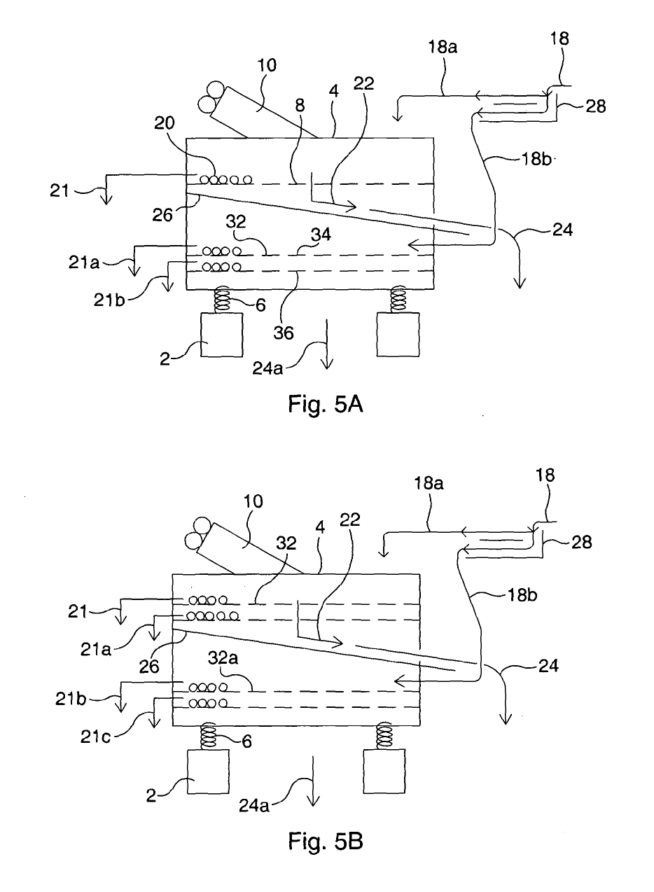

FIG. 5A shows operation of a two deck machine fitted with a flow divider for parallel processing, as in FIG. 1D but with a screen assembly of the invention 32 fitted to the lower deck. The divided input streams 18a, 18b are treated differently. The upper 18a is screened once, the lower 18b is passed successively through two screen units 34 and 36. Any of the three solids streams 21,21a,21b may be recovered for reuse.

FIG. 5B shows a similar arrangement to that of FIG. 5A except that both decks of the shaker 1 are fitted with screen assemblies of the invention 32,32a

With this arrangement both of the parallel streams are processed in the same way and any one or combination of solids streams 21,21a,21b,21c may be recycled. For example the similar solids streams 21a and 21c which select solids passing through the upper screen of the assemblies 32,32a but which do not pass through the lower screens (i.e. solids of a selected size range—between the aperture sizes of the two screen units of the screen assemblies) may be recycled. If Sized Material Retention is not required the arrangement shown still has the benefit of allowing Progressive Screening through two screens whilst operating a parallel processing procedure in a two deck machine.

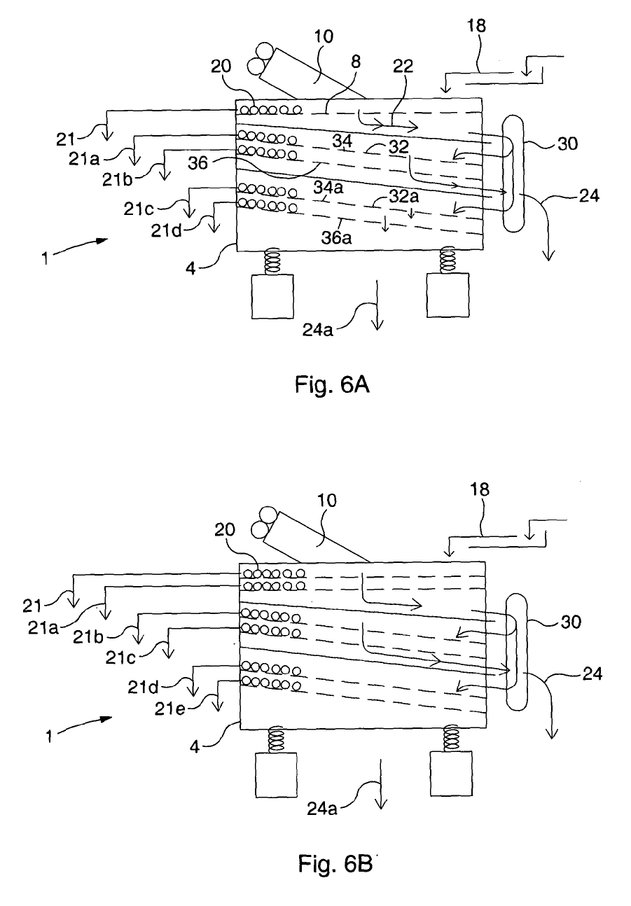

FIG. 6A shows a three deck shale shaker 1 operating in parallel as in FIG. 1E but where the second and third decks are fitted with screen assemblies 32, 32a of the invention. This allows progressive screening through a total of three screens (of increasingly finer mesh or aperture size) for the fluid/solids mixture being processed whilst still providing the benefit of a parallel processing operation (increased filter area) when using finer apertured filter panels. As before any of the solids streams produced 21,21a,21b,21c,21d may be recycled by collecting it separately or in combination with other streams as desired.

For example, a three deck screening machine such as an AX1 shale shaker as manufactured by Axiom Process Limited may be operated in parallel mode as shown in FIG. 6A while Sized Material Retention is achieved as follows:

The top machine screen assembly 8 or scalping deck processes 100% of the flow returning from the oil well and removes the majority of solids 20 above the desirable solids size range, allowing the majority of solids under the upper desirable size range to pass through the screen. Solids separated by the upper assembly 8 are rejected.

The scalping screen deck underflow is split in the flow distributor 30 into two streams. One stream will pass to the second screen deck, fitted with the screen assembly 32 and the other stream will pass to the lower screen deck fitted with the screen assembly 32a. The upper screen units 34, 34a of the assemblies 32, 32a are of a mesh that will separate solids above the lower size range of the desirable solids to be retained in the mud system. Solids separated by the upper screen units (streams 21a and 21c) are reincorporated into the mud system (screened fluids 24 and 24a). The second screen units 36,36a have a suitably fine mesh to separate remaining undesirable solids (streams 21b,21c) without removing finer dimensioned desirable solids such as weighting material, that are retained in the filtrates 24 and 24a (drilling fluid for re-use).

Solids separated by the second (lower) screen units (streams 21b,21d) of the invention are rejected.

The invention thus allows the AX1 machine to be operated in parallel mode while achieving Sized Material Retention. Prior to the invention the AX1 machine would require to have been run in series mode to achieve this duty. The result of the invention is that the solids recovery process capacity of the AX1 machine is effectively significantly increased. As the screen assembly may be fitted within a similar space in which a single layer screen was previously used the machine requires only minor modification to fit assemblies 32 and 32a. Furthermore only minor modification to the solids collection and rejection systems (appropriate chutes and conduits) is required. These can be separate from the screening machine. Thus the screen assemblies 32,32a can allow Sized Material Retention and Progressive Screening in a parallel processing mode.

FIG. 6B shows the shaker of FIG. 6A but fitted with three screen assemblies of the invention 32,32a and 32b. In this arrangement the parallel processing occurs after the feed has passed through the two screen units of assembly 32, providing for greater control of particle size and higher efficiency of processing. As before any of the solids streams produced (21, 21a to 21e) may be recovered for recycle, either individually or in any combination with any other solids stream or solids streams.

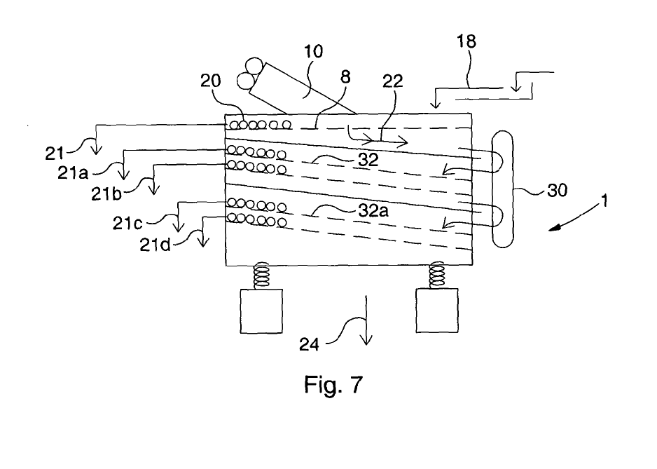

FIG. 7 shows a three deck shaker operating in series as in FIG. 1F but where the second and third decks are fitted with screen assemblies 32,32a of the present invention. The feed can thus be screened through five screening steps (progressive screening through finer apertures) in a three deck machine. Six screening steps would also be possible if upper conventional screen assembly 8 is also replaced by a screen assembly of the invention. Again solids produced at any of the screening steps may be recovered for use as desired e.g. recycling in a drilling mud.

Examples of Screen Assemblies and Optional Features.

FIGS. 8A to 8C show examples of screen assemblies 32 of the invention.

FIG. 8A shows in schematic perspective view a screen assembly 32. The assembly (a rigid or substantially rigid construction in this example) includes a support frame 38 which comprises spaced apart and parallel elongate first and second frame elements 40 and 42, with further elongate and parallel frame elements 44 in between. First and second screen units 34, 36 are screen panels 46, 48 of a wire mesh or layers of wire mesh pretensioned and fixed to an apertured plate (not shown). The screen panels 46,48 are bonded, for example by welding, riveting or gluing to the frame elements 40,42,44 of the support frame. 38.

To aid viewing of the structure of the screen assembly 38 the drawing only indicates the screen panels 46,48 by small areas of cross hatching to suggest the mesh. It will be understood that the screen panels 46, 48 cover the whole of the top and bottom faces of the assembly. The frame elements 40, 42 and 44 are sized to present a structure with arcuate top and arcuate bottom faces. Thus the assembly has a convex crown deck provided by the screen panel 46 of the first screen unit and an inverted (concave) crown deck formed by the screen panel 48 of the second screen unit 36. The frame elements and the screen panel 48 of the second screen unit define longitudinal channels 50 along which solids collected by the second screen unit may be transported, to end 14 in this example, for discharge.

The assembly 32 may have a metal, plastics or plastic coated metal support frame 38

FIG. 8B shows in schematic elevation the screen assembly 32 of FIG. 8A located in the basket 4 of a shale shaker or similar screening machine. The basket is fitted with flanges 52, 54. The edges of the assembly 32 including the spaced apart frame elements 40, 42 rest on the lower flanges 54. Activation of an inflatable tube clamping and sealing system 56 clamps the assembly 32 in place and provides a generally fluid tight seal in the known manner for conventional screen assemblies.

FIG. 8C shows in schematic elevation a modified version of the assembly of FIGS. 8A and 8B. The first and second frame elements 40 and 42 are of modified form having bottom faces 58 that are inclined downwards in the outwards direction. The lower flanges 54 in the basket 4 are correspondingly shaped, with downwardly inclined, in the outwards direction, top surfaces. This arrangement gives a more positive engagement between the flanges 54 and the screen assembly 32 on activation of the inflatable tube clamping system 56.

FIG. 9 shows another example of a (rigid) screen assembly 32. FIG. 9 shows in schematic perspective partial view an end 12 of a screen assembly 32 which has a rectangular box like structure. The support frame in this example includes (optional) bracing struts 60. The arrangement of FIG. 9 may be clamped into place in a vibratory screening machine by making use, for example of inflatable tube clamping and sealing arrangements such as those shown in FIG. 8B.

FIGS. 10A and 10B show in more detail another screen assembly 32. FIG. 10A shows in exploded perspective view the assembly 32 has five frame elements 44 of for example steel. The first and second screen units 34, 36 are of wire mesh (not shown) pre-tensioned and fused onto HDPE coated apertured steel plates. The mesh may be fitted either the top or bottom face of the to the screen apertured plates.

The steel plate of the first screen unit 34 includes downwardly projecting flanges to either side which constitute first and second frame elements 40, 42 when the assembly 32 is constructed, as can be seen in FIG. 10B. FIG. 10B shows in elevation the assembly 32 of FIG. 10A with the parts located for joining together. The first and second screen units are pop riveted to the frame elements 44. As can be seen from the figure, the outermost frame elements 44a are shorter than the middle three 44b. Therefore the assembly is completed by bending the first screen unit 34 downwards at the flanged edges, as indicated by the arrows until contact is made between the flanges (first and second frame elements 40, 42) and the second screen unit 36 to allow their fastening together. At the same time the outermost further frame elements 44a will be in contact with the first screen unit 34 and can be fastened together. The resulting screen assembly will feature a crown deck screen panel on the top and a substantially flat underside screen panel.

FIG. 11 shows in schematic elevation a screen assembly 32 featuring a first screen unit 34 similar to that of FIG. 8A and a second screen unit 36 comprising a corrugated screen panel 60. This arrangement can provide certain advantages where the second screen panel 60 has a finer or significantly finer mesh or aperture size than that of the first screen unit 34. The typically finer mesh size of second screen units will normally result in slower processing, slower filtration of the fluid and solids mixture through the second screen unit in comparison with the first, for a given screening area. The corrugated screen panel 60 compensates, at least to some extent for this by providing a greater screen surface area compared with that of the upper (first) screen unit 34.

FIG. 12 shows in partial exploded view another arrangement of a rigid or semi-rigid screen assembly 32. In this example the support frame 38 comprises spaced apart elongate frame elements 40, 42 in the form of box structures with hollow interiors 62 to reduce weight. Disposed between elongate frame elements 40, 42 is a support frame member 64 in the form of an apertured plate with a zigzag conformation and flanges 68 that rest on the upper surfaces of the frame members 40,42 in this example. The first and second screen units 34, 36 are of wire mesh 70 pretensioned and secured to substantially flat apertured steel plates 72 to form screen panels 46,48 (in common with the other illustrations provided herein, only a small part of the mesh 70 is shown).

The screen assembly 32 is constructed by bonding (for example with an adhesive or by riveting) the component parts together as suggested by the dashed line. The zigzag support frame member 64 provides a strong internal support to the cuboid, box like screen assembly, with the apertures 74 providing little impedance to flow of the filtrate from the first screen assembly 34, through to the second screen assembly 36. This arrangement also provides convenient channels 50 for the transport of solids filtered by the second screen panel 48. The components of the support frame may be of, for example steel or other metal and may be plastic coated. Typically the mesh 70 will be of a metal such as steel and the apertured steel plates 72 of the screen panels will be plastic coated, so that the mesh 70 may be fused onto them in a melting procedure.

FIG. 13A shows schematically, construction of another cuboid, box like screen assembly 32. In this example the support frame 38 comprises short but broad (the width of the screen assembly) sections of rectangular tube or box section 76 with apertured top and bottom sides 78,80 that act as apertured plates for the first and second screen units (only one box section shown in any detail). The box sections are screen modules that are bonded together as indicated by the arrows to form a suitably sized screen assembly for fitting into a screening machine basket. Alternatively the box sections may be held or clamped together in use as discussed below with respect to FIGS. 13B and 13C, and as shown in FIG. 14 as also discussed below.

In the example of FIG. 13A the screen units 34, 36 are mesh 70 secured (e.g. by bonding) to apertured top and bottom sides of the tubes 78, 80. Each box section 76 may carry its own discrete mesh 70 on a face of the top or bottom sides 78,80 thus constituting a screen module. In this example the mesh 70 on the bottom side 80 of the tubes is inside the tube, i.e. on the uppermost, in use surface of the bottom side 80. Alternatively the mesh 70 could be mounted on the underside of the side 80. Alternatively a single piece layer or layers of mesh may be disposed across the whole assembly 32 for each of the first and second screen units.

As a yet further alternative only one screen unit (the first or the second, for all modules) may be provided with mesh or other screening material. Thus the modules or the screen assembly will then only have a single screening surface but the advantages in terms of ease of construction replacement and repair remain. Such a single screening surface arrangement may be provided for all the modular examples described herein. In this example the box sections 76 are reinforced by webs 82 between the top and bottom faces which leave channels 50 for the solids filtered on the mesh of the second screen unit 36. The webs 82 and the remaining sides 83 of the box sections 76 are elements of the support frame 38.

FIG. 13B shows a similar arrangement to that of 13A except the rectangular tubes or box sections 76 are elongate and arranged so that in use they run from front to back of the basket of a vibratory screening machine, with each box section 76 forming a channel 50 as shown. In this example the box sections 76 are not bonded together but are provided as separate entities, screen modules (each having separate pieces of mesh 70 on the apertured top and bottom sides as the screen units 34, 36) that are placed in a screening machine. In this example the box sections 76 have chamfered or beveled edges 84 at one side and corresponding projecting edges 86 at the other (see detail elevation FIG. 13D), which project outwardly and engage with the beveled edges 84 of an adjacent box section 76. Thus box sections 76 placed adjacent and in contact tend to self locate and nest together to form a screen assembly 32 as indicated in the figure. Other locating means may be provided with box section or other screen module components of screen assemblies. For example they may be provided with pins or similar projections that locate in corresponding depressions or holes in an adjacent module when forming a screen assembly.

The assembly 32 of FIG. 13B is shown in the schematic elevation of FIG. 13C fitted to a basket 4 of a vibratory screening machine. The assembly rests on transverse bars 88 fitted to the basket (at least two—one towards the front and the other towards the rear of the basket, only one visible in the figure). An inflatable tube clamping and sealing system with tubes 90 similar to part 56 shown in FIG. 8B but acting horizontally and inwardly to clamp the box sections 76 into close interengagement is fitted to the basket. In this example the “rear” end of the channels 50 (i.e. distal to the end from which solids are discharged) is blanked off i.e. closed or sealed, to ensure that all the filtrate from the first screen units either passes through the second screen unit or is transported off the selected end of the second screen units as solids for recovery, re-use or disposal.

FIG. 14 shows in schematic perspective a screen assembly 32, such as that shown in FIG. 13A being secured in a basket 4 (only part shown) of a vibratory screening machine. The screen assembly 32, comprising a number of tubular or box sections 76 (modules) rests on lower flanges 54 and is clamped into place by inflatable tubes 56 acting between the assembly 32 and the upper flanges 52. A further inflatable tube 92 is fitted at one end of the assembly 32 to engage with the assembly 32, pushing the assembly against the stop 93, thus clamping the box sections 76 together and providing sealing, by the inflatable tube 92, blanking off one end of the channels that allow transport of the solids of the second screen unit.

FIG. 15A shows in schematic elevation the option of stacking screen assemblies of the invention 32 directly on top of each other. In the figure two assemblies 32a,32b are placed one on the other and clamped and sealed into a basket 4 by tube seals 56.

Thus with only minor modifications (e.g. to the location of the flanges 52,54) a single deck of the basket may be used for four stages of screening, two from each screen assembly 32, albeit without solids removal between the adjacent bottom (second) screen unit 36a of the topmost screen assembly 32a and the top (first) screen unit 34b of the second screen assembly 32b. As an alternative the mesh or other screening material used on the bottom (second) screen unit 36a of the topmost screen assembly 32a may be omitted to provide an arrangement with three screening steps. As a yet further alternative, as indicated in FIG. 15B, the stacked screen units may be separated by spacers 94. The use of spacers permits all the possible options for making use of two (or more) closely stacked screen assemblies 32a,32b. solids are obtainable from each screen unit, for recovery, recycle or reuse as desired. Thus the screen assemblies 32 may be stacked in close proximity in a basket to provide multiple screening stages in a much reduced height compared with conventional arrangements.

FIG. 16A shows in schematic elevation alternative means for fitting a modular screen assembly 32 comprising box structures 76, similar to those of FIG. 13B, to a basket 4. In this example the array of box structures are secured from above by means of a top clamp sheet 96 that is secured in clamping engagement with the basket 4 by means of inflatable tubes 56 and wedge shaped elongate top clamp support members 97 in a manner akin to that shown in FIG. 8C and described above. The clamp 96 comprises a sheet or screen of a material such as an apertured metal sheet, for example. Thus top clamp sheet may itself be a screen assembly, for example of an apertured plate supporting a screen mesh. Longitudinal ribs 98 project downwards and engage with adjacent box sections 76 at the edges where they abut by means of seals 100 (for example of an elastomer) which act to prevent unscreened material by-passing the box sections 76 by passing between adjacent box sections. The sheet 96 forms an arcuate shape in use, as shown The assembly is supported from underneath by transverse bottom support members 102 (only one shown). In this example members 102 are square tubes i.e. box sections permanently secured to the basket 4. Optional short upwardly projecting ribs 104 running contact the box sections 76 and may have sealing connection thereto as for ribs 98.

FIG. 16B shows a similar arrangement to that of FIG. 16B except that the top clamp is constituted by transverse support members, box sections 106 (only one shown), rather than a sheet.

FIGS. 17 and 17A show fitting of screen assemblies 32 into a basket 4 fitted with an additional support frame 108. The additional support frame 108 has elongate frame elements or ribs 96 running from front to back of the basket and sized (in height) to shape a flexible or semi-rigid screen assembly 32 into a curved, crown deck shape as shown. In FIG. 17 inflatable tubes 56 clamping is employed with the side edges of the screen assembly, the spaced apart elongate frame elements 40 and 42, having outwardly downwards inclined bottom faces 58 (see FIG. 8C) that engage with corresponding top surfaces of the lower flanges 54. This gives secure clamping and tensioning to the assembly 32, in the basket and across the additional support frame 108. These semi-rigid screen assemblies may be constructed of plastics, metals such as steel or composites.

In FIG. 17A an alternative means of securing the screen assembly 32 is shown. The assembly 32 has hooks or flanges 112 projecting upwards from the side edges that engage with tensioning rails 114 that are pulled outwardly by bolts 116 or similar tensioning means, i.e. this assembly 32 is secured in place in a manner akin to the known “hook strip” screen systems.

In FIG. 17B a detail of the assembly 32 and basket 4 of FIG. 17 is shown in perspective view. As can be seen in this view the additional support frame 108 has transverse base support bars 118 (only one shown) that support the ribs 110. The screen assembly has pre-tensioned mesh or meshes 70 on apertured support plates 72 forming screen panels 46,48 that constitute the screen units 34,36.

FIG. 18 illustrate the use of a rigid support frame 38 with semi-rigid (i.e. resilient) screen units 34, 36.

Schematic elevation view FIG. 18 shows a rigid support frame 38 of plates or webs 120 and interconnecting rods 122 (shown in detail FIG. 18A) and having spaced apart first and second elongate frame elements 40,42 in the form of triangular prisms. Above and below the support frame 38 are located first and second screen units 34, 36. In this example the screen units comprise screen panels 46, 48 of pretensioned mesh supported on apertured steel plates with wedge shaped (in cross section) screen panel support members 124 running along opposite side edges. The separate screen units and support frame can all be clamped and sealed into place by an inflatable tube 56 clamping and sealing system in like manner to the screen systems described above (FIGS. 8C and 17) This arrangement has the advantage that any of the screen units or support frames may be separately replaced when worn or damaged.

FIG. 18B shows a similar arrangement to that of FIG. 18 except that the support frame 38 is permanently secured in the basket, with the first and second elongate frame elements 40,42 being welded or otherwise fixed to the walls of the basket 4.

FIG. 19 illustrate schematically the discharge of screened solids 20 from the end of screen assembly 32. In FIG. 19 the solids 20, 20a from the first and second screen units 34, 36 are directed down different sloping panels or chutes 126 into different locations 128, which may be, for example, containers for collecting solids for disposal or further processing or a conduit leading to such containers. Where solids are being recycled to a filtrate the chutes may lead (via a conduit if required) to a holding tank for the filtrate (that may be fitted with agitation means) or directly to a conduit containing filtrate flow.

In FIG. 19A the first and second screen units are of different sizes, with the first screen unit 34 projecting past the end 130 of the second screen unit 36. Thus the two separate sets of solids 20, 20a being discharged (streams 21,21a) can simply fall by gravity into their respective locations 128 without the need for chutes or other conveyance means at the discharge points from the screen units.

FIG. 19B illustrates in a detail a screen assembly 32 with frame elements 40,42,44 (only one shown) shaped to support the first screen unit 34 as it projects past the end 130 of the second screen unit 36.

FIG. 20 shows another approach to making use of screen modules such as the box sections 76 of FIGS. 13B and 16. In this schematic partial elevation a screen assembly 32 is shown resting on a transverse support 88 of a shale shaker basket (not shown). The screen assembly comprises box sections 76 (76a,76b) as screen modules, held together by longitudinal supports 132, in a pattern of upper (76a) and lower (76b) modules with each lower module 76b being secured to an adjacent longitudinal support 132 and each upper module 76a being secured on top of a longitudinal support. A schematic perspective of a supports 132 is shown in FIG. 20A. In this example they are apertured ‘X’ form structures of sheet metal. The longitudinal supports 132 may be attached to the modules 76 by releasable fixings such as bolts or spring clips. Seals of for example an elastomer, may be employed between adjacent edges of modules 76a and 76b.

The arrangement shown has the advantage that the assembly 32 can be conveniently mounted in a vibratory screening machine as a single unit, but at the same time when a screen unit of one of the modules becomes damaged it can readily be removed and replaced. A further advantage in terms of screening surface area may be obtained by providing a screening surface, for example a screen mesh on an apertured plate on the elongate exposed side faces 140 of the upper modules 76a.

The screen modules employed in an arrangement of alternating upper and lower screen modules such as shown in the example of FIG. 20 may take different forms. For example elongate triangular prisms 142, elongate half cylinder 144 (see FIG. 20B) or other complex shapes. Appropriate longitudinal supports can be used to aid connecting together to form a screen assembly. The upper two surfaces of the triangular prism may be used as the first screen unit and the bottom face as the second screen unit. Similarly the curved surface of the half cylinder can for the first screen unit of the module 144 with the bottom flat face as the second screen unit.

FIG. 20C shows an arrangement of screen modules 76 (76c, 76d) where alternating modules 76c, 76d have differing heights. This provides a screen assembly with a similar top surface to that of FIG. 20 but without requiring additional longitudinal supports. The option of additional screening surface area on exposed side faces 140 of modules 76c is available in such an assembly.

FIG. 21 shows an assembly 32 similar to that of FIG. 13B being clamped into a basket 4 of a vibratory screening machine. In this example the assembly 32 rests on transverse supports 88 of a secondary support frame 133 (see plan view FIG. 21A). The assembly of box sections (modules) 76 is clamped into the basket 4 by means of inflatable tubes 56 acting on wedge shaped (in cross section) longitudinal members 134. These members 134 may be attached to their adjacent modules 76 or may be detached or detachable. When the inflatable tubes 56 are inflated the inclined plane of the members 134 causes a clamping action as indicated by arrows 135, inwards and downwards. The modules or box sections 76 may have the form of those shown in FIG. 13D, to further assist positive engagement between the modules when clamped together.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A screen assembly for use in a vibratory screening machine, the screen assembly comprising first and second screen units spaced apart by a support frame interposed between the screen units;
wherein said first and second screen units each comprise a screen panel including screening material; the screen panel of the first screen unit is disposed, in use, across a top side of the support frame and the screen panel of the second screen unit is disposed, in use across an underside of the support frame; and
wherein the support frame and second screen unit define at least one channel formed and arranged so that solids collected by the second screen unit may be transported off an end of the screen unit by the vibratory action of a said vibratory screening machine.

2. A screen assembly according to claim 1 wherein the apertures in the first screen panel are larger than the apertures in the second screen panel.

3. A screen assembly according to claim 1 wherein the apertures in the first screen panel are of the same size as those in the second screen panel.

4. A screen assembly according to claim 1 wherein the first and second screen panels are held in tension across and in contact with the support frame.

5. A screen assembly according to claim 1 provided with more than two screen units, with each screen unit spaced apart from the preceding by a further support frame.

6. A screen assembly according to claim 1 wherein the screen panels are substantially planar in use.

7. A screen assembly according to claim 1 wherein the screen panels are corrugated.

8. A screen assembly according to claim 1 wherein the screen panels are provided in the form of a pre-tensioned mesh layer or layers of mesh fitted to an apertured plate.

9. A screen assembly according to claim 1 wherein the screen units are formed and arranged for clamping into contact with the support frame and tensioned across the said support frame when the screen assembly is fitted to a vibratory screening machine.

10. A screen assembly according to claim 1 further provided with flow back means incorporated between the first and second screen units.

11. A screen assembly according to claim 1 further comprising at least one baffle to provide control of fluid flow between the first and second screen units.

12. A screen assembly according to claim 1 further comprising blanking off means to prevent solids screened by the second screen unit or filtrate from the first screen unit moving off the second screen unit in an undesired direction.

13. A screen assembly according to claim 1 wherein the support frame comprises a rectangular box like structure.

14. A screen assembly according to claim 1 wherein the support frame comprises a zig-zag or corrugated sheet of a rigid or semi-rigid material, with apertures provided to allow passage of filtrate.

15. A screen assembly according to claim 1 wherein the support frame comprises interconnected rods or a combination of rods and plates formed to hold the first and second screen units spaced apart.

16. A screen assembly according to claim 1 comprising a plurality of screen modules, each screen module including first and second screen units and support frame elements; and being formed and arranged for locating together in a vibratory screening machine to form the screen assembly.

17. A screen assembly according to claim 16 wherein the screen modules are rectangular box like structures each having a top and bottom surface that takes the form of an apertured plate to which is attached a screening material.

18. A screen assembly according to claim 1 wherein at least one of the first or second screen units takes the form of a crown deck.

19. A screen assembly according to claim 1 wherein an end of the first screen unit from which screened solids are discharged in use of the assembly extends in a horizontal direction further than the corresponding end of the second screen unit.

20. A screen assembly cassette for fitting to a vibratory screening machine and comprising first and second screen units fixed to and spaced apart by a support frame interposed between the screen units;
wherein said first and second screen units each comprise a screen panel including screening material; the screen panel of the first screen unit is disposed, in use, across a top side of the support frame and the screen panel of the second screen unit is disposed, in use across an underside of the support frame; and
wherein the support frame and second screen unit define at least one channel formed and arranged so that solids collected by the second screen unit may be transported off an end of the screen unit by the vibratory action of a said vibratory screening machine.

21. A method for screening a solids mixture or a solids and liquid mixture the method comprising:
a) providing: a screen assembly for use in a vibratory screening machine, the screen assembly comprising first and second screen units spaced apart by a support frame interposed between the screen units; wherein said first and second screen units each comprise a screen panel of screening material, the screen panel of the first screen unit is disposed, in use, across a top side of the support frame and the screen panel of the second screen unit is disposed, in use across an underside of the support frame; and wherein the support frame and second screen unit define at least one channel formed and arranged so that solids collected by the second screen unit may be transported off an end of the screen unit by the vibratory action of a said vibratory screening machine;
b) installing the screen assembly in a vibratory screening machine;
c) screening a said solids mixture or a solids and liquid mixture through the screen assembly installed in the vibratory screening machine.

22. A method according to claim 21 further comprising recovering at least one selected solids stream from a screening step for the purpose of any one of recycle, reuse and further processing.

23. A method according to claim 21 wherein at least one solids stream produced by a screening step carried out in the machine is directed back into a screened fluid product from the machine.

24. A screen module for use in forming a screen assembly for a vibratory screening machine said screen module comprising first and second screen units spaced apart by a support frame interposed between the screen units;
wherein said first and second screen units each comprise a screen panel including screening material; the screen panel of the first screen unit is disposed, in use, across a top side of the support frame and the screen panel of the second screen unit is disposed, in use across an underside of the support frame; and
wherein the support frame and second screen unit define at least one channel formed and arranged so that solids collected by the second screen unit may be transported off an end of the screen unit by the vibratory action of a said vibratory screening machine.

25. A screen module according to claim 24 comprising a rectangular tube or box sections with apertured top and bottom sides.

26. A screen module according to claim 24 provided with engagement means for nesting or interlocking engagement with another screen module.

27. A screen module according to claim 24 wherein one of the first and second screen units does not include screening material.

28. A screen assembly comprising a plurality of screen modules each according to claim 24.

29. A screen assembly according to claim 28 wherein the screen modules are bonded together, or secured one to another by permanent or releasable fastenings.

30. A screen assembly according to claim 28 wherein the modules are fixed into a frame, permanently or releasably, to constitute the screen assembly before being fitted into a vibratory screening machine.

31. A screen assembly according to claim 28 wherein the plurality of screen modules are placed in a vibratory screening machine provided with a clamping system that holds the modules together as a screen assembly.

32. A screen assembly according to claim 28 wherein the plurality of screen modules are attached one to another with the use of additional support elements.

33. A screen assembly according to claim 32 wherein the modules are connected with the use of additional support elements to form an array of alternating upper and lower modules.

34. A screen module for use in forming a screen assembly for a vibratory screening machine, said screen module comprising;
a screen unit mounted on a support frame wherein said screen unit comprises a screen panel including screening material; wherein the screen panel of the screen unit is disposed, in use, across a top side or across a bottom side of the support frame.

35. A screen assembly comprising a plurality of screen modules each according to claim 34.
